(19) United States
(12) Patent Application Publication
(10) Pub. No.: US 2026/0212259 A1
(43) Pub. Date: Jul. 23, 2026

(54) SYSTEMS AND METHODS FOR MACHINE LEARNING BASED EVENT PREDICTION

(71) Applicant: DISH Network L.L.C., Englewood, CO (US)

(72) Inventor: Ashwini Kumar Singh, Englewood, CO (US)

(21) Appl. No.: 19/035,713

(22) Filed: Jan. 23, 2025

(51) Int. Cl. G06N 20/00

(52) U.S. Cl. CPC G06N 20/00

(57) ABSTRACT

The document relates to systems and methods for machine learning based event prediction. In some embodiments, a computer-implemented method includes generating a configuration file; automatically preparing training data based on the configuration file; automatically generating one or more machine learning models based on the training data; and providing output of model training and evaluation results.

### BACKGROUND

Employee turnover poses a significant challenge to the productivity and stability of organizations. When an employee departs, it often results in a loss of time, resources, and institutional knowledge invested in that individual, potentially leading to decreased efficiency and increased costs for recruitment, onboarding, and training of replacements. Additionally, such turnover can have cascading effects on the morale and productivity of remaining personnel, often disrupting team dynamics and affecting overall organizational performance.

### SUMMARY

An aspect of the present document relates to a computer-implemented method for generating machine learning models configured to make event prediction. In some embodiments, the method includes generating a configuration file; automatically preparing training data based on the configuration file; automatically generating one or more machine learning models based on the training data; and providing output of model training and evaluation results. In some embodiment, the generation of the configuration file includes identifying, in the configuration file, one or more data sources; defining one or more groups for the one or more data sources; and assigning one or more features to each of the one or more groups. In some embodiments, the automated preparation of the training data based on the configuration file includes retrieving data from the one or more data sources identified in the configuration file; validating the retrieved data to detect duplicates, null values, and inconsistencies, and obtaining the training data by performing data imputation or removal for detected null values based on predefined rules specified in the configuration file. In some embodiments, the automated generation of one or more machine learning models based on the training data includes training one or more models using the training data according to the configuration file; evaluating performance of each trained model based on predefined performance metrics; and selecting one or more top-performing models based on the performance evaluation.

Another aspect of the present document relates to a computer-implemented method for machine learning based event prediction. In some embodiments, the method includes obtaining a configuration file; automatically preparing data based on the configuration file; automatically generating predictions; and providing output based on the generated predictions. In some embodiments, the automated data preparation includes retrieving data from one or more data sources identified in the configuration file; and validating the retrieved data by detecting duplicates, null values, and inconsistencies and performing data imputation or removal for detected null values based on predefined rules specified in the configuration file. In some embodiments, the automated prediction generation includes obtaining one or more machine learning models; and applying the one or more models to the prepared data to generate initial predictions.

A further aspect of the present document relates to one or more non-transitory computer-readable storage media storing processor-executable code. The code included in the computer-readable storage media when executed by one or more processors, causes the one or more processors to implement the methods described in the present document.

A still further aspect of the present document relates to a system, including memory storing computer-readable instructions; one or more processors that when executing the computer-readable instructions, are configured to perform the methods disclosed in the present document.

### BRIEF DESCRIPTION OF THE DRAWINGS

FIG. 1 is a flow diagram illustrating how to generate employee attrition predictions, according to some embodiments.

FIG. 2 is an architectural diagram showing an employee attrition prediction system and framework, according to some embodiments.

FIG. 3 is a GUI that provides various results of employee churn prediction, according to some embodiments.

FIG. 4 illustrates a GUI that provides prediction results of an employee's attrition risk, according to some embodiments.

FIG. 5 illustrates a GUI a GUI that provides prediction results of different types of employees over a time period, according to some embodiments.

FIG. 6A is a flow diagram for a process 600A for developing machine learning models for employee attrition prediction, according to some embodiments

FIG. 6B illustrates a process 600B for applying trained machine learning models for employee attrition prediction, according to some embodiments.

FIG. 7 is a block diagram illustrating an overview of devices on which some implementations of the disclosed technology can operate, according to some embodiments.

FIG. 8 is a block diagram illustrating an overview of an environment in which some implementations of the disclosed technology can operate, according to some embodiments.

FIG. 9 is a block diagram illustrating various components which can be used in a system employing the disclosed technology, according to some embodiments.

FIG. 10 illustrates an AI architecture, according to some embodiments.

The headings provided herein are for convenience only and do not necessarily affect the scope of the embodiments. Further, the drawings have not necessarily been drawn to scale. For example, the dimensions of some of the elements in the figures may be expanded or reduced to help improve the understanding of the embodiments. Moreover, while the disclosed technology is amenable to various modifications and alternative forms, specific embodiments have been shown by way of example in the drawings and are described in detail below. The embodiments are intended to cover all suitable modifications, combinations, equivalents, and alternatives falling within the scope of this disclosure.

### DETAILED DESCRIPTION

Various examples of the systems and methods introduced above will now be described in further detail. The following description provides specific details for a thorough understanding and enabling description of these examples. One skilled in the relevant art will understand, however, that the techniques and technology discussed herein may be practiced without many of these details. Likewise, one skilled in the relevant art will also understand that the technology can include many other features not described in detail herein. Additionally, some well-known structures or functions may not be shown or described in detail below so as to avoid unnecessarily obscuring the relevant description.

The terminology used below is to be interpreted in its broadest reasonable manner, even though it is being used in conjunction with a detailed description of some specific examples of the embodiments. Indeed, some terms may even be emphasized below; however, any terminology intended to be interpreted in any restricted manner will be overtly and specifically defined as such in this section.

The present disclosure introduces a versatile computer-implemented framework for utilizing advanced machine learning techniques across a broad spectrum of data analysis and decision-making tasks. This technical solution addresses challenges in processing multi-source data, performing automated data preparation and validation, and applying sophisticated machine learning algorithms to extract insights and generate outputs for various applications.

The framework's architecture is designed to be scalable and adaptable, capable of handling diverse machine learning tasks through a unified approach. These tasks may include, but are not limited to, predictive analytics, classification, clustering, anomaly detection, and natural language processing. While the framework's capabilities extend beyond any single application, the remainder of this description will reference employee attrition prediction for illustrative purposes. It should be understood that this focus is not intended to be limiting, as the disclosed technology is applicable to a wide range of machine learning scenarios.

The framework's versatility is demonstrated through its ability to adapt to different analysis tasks by defining relevant entities and events or outcomes of interest. For instance, in employee attrition scenarios, entities are employees, and events of interest may include attrition. In customer behavior analysis, entities are customers, and the outcomes of interest may include purchase patterns, sentiment, or lifetime value. In student retention analysis, entities are students, and events of interest may include dropouts. The framework can be applied to numerous domains, including customer churn analysis, loan default assessment, and patient disease risk evaluation. In each case, the framework processes domain-specific data points and applies appropriate machine learning techniques to generate insights or predictions. For example, in financial applications, it might employ regression models or decision trees to assess loan default risk. In healthcare scenarios, it could utilize deep learning or ensemble methods to evaluate disease risk based on complex medical data. The framework's underlying algorithms and data processing mechanisms remain consistent across these varied applications, showcasing its technical robustness and flexibility.

By providing a unified, technically advanced approach to diverse machine learning tasks, this framework represents a significant advancement in the field of artificial intelligence and data science. Its ability to adapt to various domains while maintaining a consistent technical core underscores its potential as a powerful tool for addressing complex analytical challenges across multiple industries and applications.

From a technical perspective, the framework incorporates advanced data preprocessing techniques, feature engineering algorithms, and a suite of machine learning models capable of handling high-dimensional data and complex patterns. Its modular architecture allows for the integration and selection of various machine learning algorithms, enabling the framework to adapt to the specific requirements of each task.

The framework's technical features include its ability to efficiently process and analyze data from diverse sources with minimal user intervention. The framework includes a configuration stage where a configuration may be specified for guiding an automated process of data retrieval, processing, and use in model training and model application. This stage allows for the development of a desired configuration that defines how various data sources should be involved, interpreted, and integrated. Once this configuration is established, the rest of the framework can proceed automatically, and at least a portion of the framework may proceed in parallel, according to the specified configuration. This approach significantly reduces the manual effort typically needed for data integration and preparation. Beyond this initial setup, the framework automatically handles data retrieval, data preparation including, e.g., handling data inconsistencies, missing values, and outliers across the diverse data sources. It employs sophisticated feature selection and dimensionality reduction techniques to improve model performance and computational efficiency. Additionally, the framework includes built-in mechanisms for model interpretability and explainability, allowing for the extraction of insights into the factors driving the machine learning outputs. This combination of automated data handling, parallel processing, and advanced analytics capabilities represents a significant advancement in the field of machine learning frameworks.

The framework incorporates advanced data visualization capabilities, transforming complex multidimensional data into graphical representations. These visualization tools are integrated with the framework's data processing and machine learning components, allowing for real-time updates and interactive exploration of results. The system includes customizable rendering engines that can generate various visual elements such as graphs, heat maps, and multidimensional plots based on the underlying data structures and machine learning outputs. Users can interact with these visualizations to dynamically adjust parameters, filter source data or results, or drill down into specific data points, triggering on-the-fly recalculations and updates to the presented information. This tight integration between the visualization layer and the core machine learning processes enables efficient exploration of high-dimensional data spaces and facilitates the identification of patterns or anomalies that may be difficult to detect through traditional data analysis methods. The framework also provides programmatic interfaces for extending its visualization capabilities, allowing for the integration of domain-specific visual representations or the incorporation of novel visualization techniques as they emerge in the field of data science.

For illustration purposes and not intended to be limiting, the following descriptions are provided with reference to employee attrition prediction. Employee turnover may present a substantial obstacle to organizational productivity and stability. The departure of an employee can lead to the loss of time, resources, and institutional knowledge that were invested in that individual, often resulting in decreased operational efficiency and higher expenses for recruiting, onboarding, and training replacements. Moreover, such turnover can have a ripple effect on the morale and productivity of the remaining workforce, disrupting team dynamics and impairing overall performance. A challenge organizations face is the absence of predictive insights into attrition risks. Without reliable forecasting tools, companies are often forced to respond to turnover only after an employee has decided to leave, limiting their ability to proactively address underlying issues or implement timely retention strategies. This reactive approach not only hinders effective human resource management but also diminishes the opportunity to mitigate factors contributing to attrition, such as job dissatisfaction, lack of engagement, or external opportunities.

Hence, there is a technical need for a solution that can analyze various parameters of the workforce, predict potential attrition risks accurately, and generate reports that empower human resources (HR) departments or personnel to proactively address and mitigate the factors leading to employee turnover. A solution of this nature may not only preserve organizational talent but also enhance overall workforce productivity and morale by allowing informed, data-driven human resource management.

Embodiments herein address significant employee turnover and the problems associated therewith. The technology addresses the lack of predictive insights for attrition risks. Embodiments herein provide a predictive model to identify at-risk employees and generate a report (e.g., a “Talent at Risk” report). Such insights may enable HR to work closely with respective Business Units to address potential turnover risks through tailored interventions, thereby reducing attrition rates and maintaining organizational stability.

Such a predictive solution may empower HR departments or personnel to move beyond reactive strategies, which often occur only after an employee decides to leave, and adopt a proactive approach to employee management. By providing actionable insights through detailed, tailored reports, the disclosed embodiments herein may enable HR professionals to engage in timely interventions, such as addressing job satisfaction issues, offering targeted development opportunities, and enhancing employee engagement.

The disclosed systems and methods herein may introduce sophisticated algorithms and computational techniques to handle large volumes of workforce data in real time. By automating the process of data collection, labeling, and analysis, disclosed systems and methods may improve the efficiency and accuracy of identifying patterns and trends related to employee attrition. This enhancement may allow organizations to leverage big data and machine learning models more effectively, providing deeper insights compared to traditional human analysis or simpler computing tools.

Indeed, traditional methods of identifying at-risk employees often rely on retrospective data and generalized indicators that may not capture all the nuances of workforce dynamics. By utilizing advanced machine learning techniques, the disclosed systems and methods may improve the accuracy of predicting potential employee turnover. This improvement would come from the system's ability to continuously learn from new data, adapt to emerging patterns, and fine-tune its predictive models to become more precise over time.

The disclosed systems and methods may offer an automated decision-support feature that provides HR with prioritized recommendations on which employees are at high risk of attrition and which interventions are likely to be most effective. This capability may improve upon existing computing by reducing the manual workload of HR professionals and allowing them to focus on strategic decision-making rather than routine data processing and analysis.

Additionally, unlike existing fragmented solutions that may need manual data integration or exist as standalone applications, the disclosed systems and methods may be designed to integrate with various Human Capital Management (HCM) systems, payroll databases, performance management tools, and other existing software used by the organization. This seamless integration may improve computing by creating a unified, holistic platform where data can be cross-referenced and analyzed without the need for extensive data migration or transformation.

Moreover, traditional approaches to employee retention often rely on periodic assessments and outdated data, making it difficult to take timely action. The disclosed systems and methods may offer real-time analytics and dynamic reporting, providing HR with up-to-date, actionable insights. Such improvements may enhance existing computing by reducing delays in data analysis and empowering organizations to implement immediate and informed interventions.

Furthermore, the disclosed systems and methods may be designed to scale effectively as an organization grows and changes. This flexibility may improve upon existing computing solutions, which may struggle to handle large and evolving datasets. Moreover, the disclosed systems and methods may allow for customizable models tailored to specific business units, departments, or regional needs, making it more adaptable and relevant to an organization's unique workforce structure.

In addition, the disclosed systems and methods may provide intuitive user interfaces and visualization tools that transform complex data into easy-to-understand dashboards and reports. By leveraging interactive visual elements, such as graphs, heat maps, and risk assessments, HR can quickly interpret data and identify at-risk employees. This enhancement may improve upon existing computing by simplifying the process of data-driven decision-making and making the predictive insights accessible to non-technical users.

The disclosed systems and methods' predictive capabilities may also enable organizations to adopt proactive strategies for workforce management, such as targeted retention programs, career development paths, and employee wellness initiatives. In contrast to traditional computing systems that often provide retrospective data, this technology employs advanced algorithms to forecast future trends and potential events. By leveraging machine learning models and real-time data analysis, the system enables proactive decision-making and strategic planning. This forward-looking approach allows for the early identification and mitigation of potential issues, thereby preventing their escalation into more significant problems.

### Overview—Model Training and Evaluation

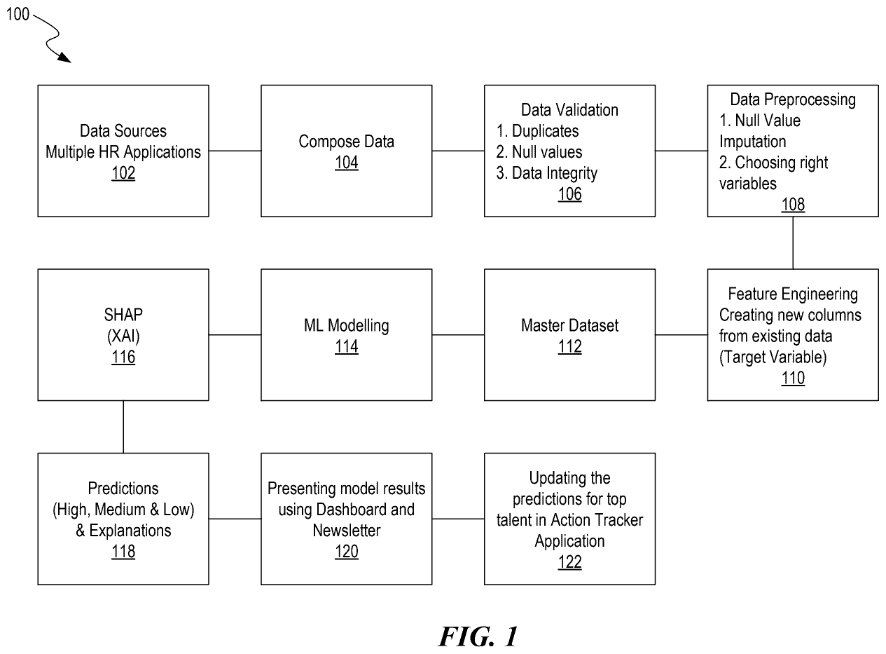

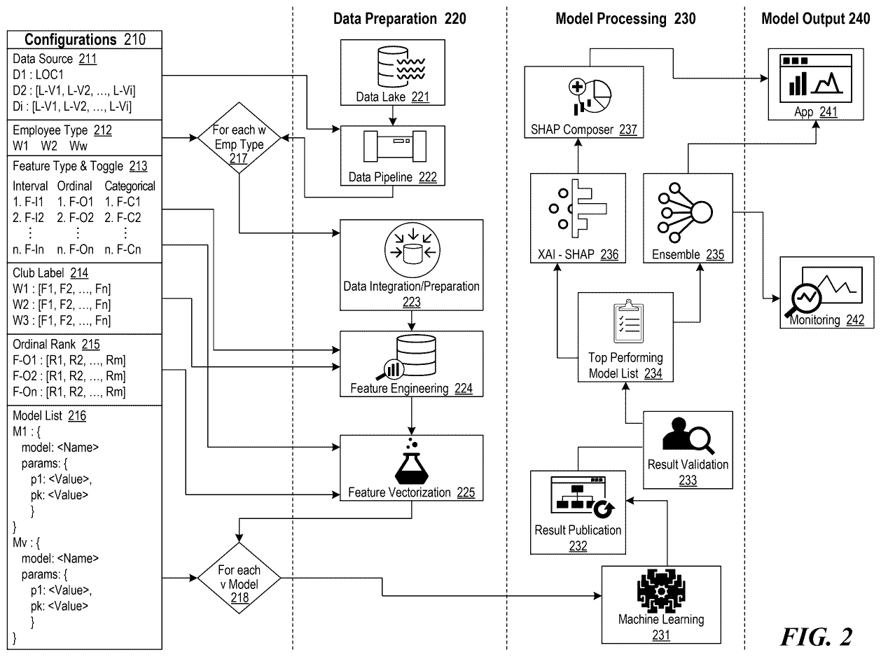

FIG. 1 is a flow diagram illustrating how to generate event predictions according to some embodiments. For illustration purposes and not intended to be limiting, FIG. 1 illustrate a flow 100 (“flow 100”) for predicting employee attrition, in accordance with embodiments herein. This framework provides a machine learning solution for processing data from various sources, preparing and validating it for modeling, and then generating actionable predictions. FIG. 1 depicts several stages or operations corresponding to those components described in FIG. 2.

In FIG. 1, data sources 102 may represent the multiple data repositories or HR applications from which data may be retrieved. Similar to data lake 221 in FIG. 2, these sources may include different types of information, such as employee records, payroll data, or other organizational databases. Flow 100 may utilize these sources to collect the desired data for predictive modeling and analysis of employee attrition.

Compose data 104 may indicate a stage where data from the various data sources 102 is organized and structured. At this stage 104, data from multiple sources is consolidated into a unified dataset. Compose data 104 may include one or more operations including combining and aligning the data fields, and preparing data for subsequent validation. The stage may correspond to data pipeline element 222 in FIG. 2.

Data validation 106 is the stage where flow 100 performs checks on the composed data from the stage of compose data 104 for irregularities including, e.g., duplicates (e.g. redundant entries), null values (e.g., missing or empty data points), data integrity (e.g., adherence to predefined rules or constraints), and/or consistency (e.g., logical relationship between different data fields). This validation process may identify and resolve incompleteness and/or inconsistencies in the dataset before further processing, to ensure data completeness and/or accuracy. The stage may correspond to how data integration and preparation element 223 manages data validation in FIG. 2.

Data preprocessing 108 refers to the stage of handling data by cleaning and/or transformation before feature engineering, corresponding to the operation of the data pipeline element 222 in FIG. 2. Flow 100 may apply imputation for null values and select appropriate variables for modeling. This preprocessing stage may enable flow 100 to standardize the dataset, ensuring it is suitable for subsequent analysis and modeling. The stages of compose data 104, data validation 106, and/or data preprocessing 108 may correspond to the data integration and preparation element 223 in FIG. 2.

Feature engineering 110 is the stage where flow 100 creates or identify features or variables based on existing data, e.g., validated and preprocessed data obtained from stages 104-108. This stage corresponds to feature engineering element 224 in FIG. 2. The stage of feature engineering 110 may include categorizing data into types, such as interval, ordinal, or categorical, and applying transformations to derive meaningful features that can improve model performance. For example, creating columns (e.g., features) for a target variable that represents an employee's attrition risk.

Master dataset 112 may indicate a consolidated dataset that has undergone composition, validation, preprocessing, and feature engineering. This dataset is similar to the output from data preparation component 220 in FIG. 2. The master dataset 112 may include the training data converted into numerical vectors suitable for machine learning algorithms, as described with reference to feature vectorization element 225. The master dataset 112 can be used as training data for training or testing of machine learning models. The master dataset may also be used as input to a trained machine learning (ML) model for making predictions for specific employees based on one or more trained ML models.

ML modeling 114 represents the machine learning modeling stage including training, testing, and evaluating predictive models. This stage 114 corresponds to model processing component 230 in FIG. 2, which includes one or more of training models (e.g., machine learning element 231 in FIG. 2), publishing results (e.g., results publication element 232 in FIG. 2), and validating model performance (e.g., results validation element 233 in FIG. 2). Multiple models may be trained and assessed to determine which one or more models yield most accurate predictions.

SHAP (XAI) 116 refers to SHAP (SHapley Additive exPlanations), which is used for model interpretability and explainability, corresponding to SHAP element 236 and SHAP composer 237 in FIG. 2. Flow 100 may include using SHAP to evaluate how individual features contribute to model predictions, allowing for transparent analysis of how risk factors influence employee attrition predictions.

Predictions and explanations 118 indicate compiling, for presentation or output, the model predictions, including categorizing the predicted risk levels (e.g., high, medium, low). This stage is similar to model output component 240 in FIG. 2, where app 241 may present the predictions and explanatory insights to a user through a user interface. Flow 100 may include categorizing employees based on their predicted attrition risk and providing explanations for these predictions, leveraging SHAP results for transparency.

Presenting model results 120 refers to the stage of presenting model predicted results through, e.g., dashboards or newsletters. This is analogous to how app 241 in FIG. 2 enables user interaction and visualization of model. Flow 100 may include creating interactive dashboards to allow users to explore predictions, filtering results based on parameters, and presenting key metrics (e.g., accuracy, recall, F1 score).

Updating predictions in action tracker application 122 illustrates the capability to update predictive insights, e.g., into an actionable application. For example, flow 100 allows an ongoing tracking of high-potential employees and their attrition risk over time. This corresponds to monitoring element 242 in FIG. 2, where ongoing model evaluation and updates may be performed to ensure the continuous accuracy and relevance of predictions.

The stages or components of flow 100 shown in FIG. 1 are similar or correspond, structurally and/or functionally, to those depicted in FIG. 2. Both diagrams illustrate a systematic framework of providing a configuration for preparing data, data extraction, preparation, model training, explainability, and output generation. The components or stages across these figures are interchangeable, and one skilled in the art can readily recognize their similarities and correspondence and how they operate within the overall machine learning framework for, e.g., attrition prediction.

FIG. 2 is an architectural diagram showing an attrition prediction system (“system 200”), according to some embodiments. System 200 may include configuration component 210, data preparation component 220, model processing component 230, and model output component 240. In some embodiments. System 200 may be configured to determine a configuration about certain data, preparing training data based on the configuration, train one or more machine learning models using the training data, and produce an outcome using the training machine learning model(s).

The configuration component 210 may generate a configuration file that guides the retrieval of datasets from one or more data sources, prepares these datasets for model training and application, and model training. The configuration component 210 may include data source element 211, employee type element 212, feature type and toggle element 213, club label element 214, ordinal rank element 215, and model list element 216. This component's functionality is adaptable to various use cases. With employee attrition prediction serving as an illustrative example, the configuration component 210 may, based on user input, determine a configuration file by specifying appropriate data sources, employee types, feature types and toggles, club labels, ordinal ranks, and a list of applicable machine learning models.

It is understood that the framework's versatility extends beyond the specific exemplary use case of employee attrition production. For a different use case, the employee type element 212 may be an entity type element. For instance, in a customer behavior prediction scenario, the configuration component 210 may include customer related parameters such as customer types (e.g., online customers, local customers) specified by the entity type element, instead of employee types. This flexibility allows the framework depicted in FIG. 1 or FIG. 2 to be applied across diverse domains while maintaining a consistent underlying structure. The configuration component 210's ability to adapt to different data types and domain-specific parameters enables the system to address a wide range of predictive analytics challenges, from human resources to customer relationship management, all within the same technical framework.

Configuration component 210 may operate within a hardware and software environment configured or optimized for efficient data handling and model training. In some embodiments, configuration component 210 resides in a database or configuration repository within a storage system, which may be deployed on either a cloud-based server or an on-premises server infrastructure. The storage system may be implemented using a relational database with predefined schemas, a non structured query language (NoSQL) database capable of handling both structured and unstructured data formats, or any other suitable data storage solution that can effectively manage multiple configurations and their associated parameters.

Data source element 211 includes information of i data sources in accordance with some embodiments. Data sources, labeled as D1, D2, . . . , Di, respectively, may correspond to different locations or data repositories from which system 200 can retrieve data. These data sources can include various types of information, such as human resources (HR) databases, employee records, or other sources of employee data. System 200 may support a wide range of data sources, making it adaptable for model training and employee attrition prediction across diverse organizational contexts.

In some embodiments, a data source Di may be characterized by specific attributes or categories of data, such as location identifiers, employee features, or data points relating to business operations. For instance, data source D1 may represent data from a single source (e.g., a centralized HR database) with a location identifier LOC1, whereas data source D2 may represent a distributed source containing multiple locations, such as L-V1, L-V2, . . . , L-Vi. System 200 can have robust data integration capabilities so as to flexibly handle various types of data structures, whether they come from a centralized or distributed data source.

Data source element 211 includes data source information (e.g., metadata) of data sources that can guide a data retrieval process, rather than containing the actual data from these data sources. This architectural approach allows for dynamic and efficient data access. The data source element 211 may include data source information for identifying databases, log files, web sites or the like from which data may be retrieved. For example, a specific configuration file includes information from the data source element 211 about one or more data sources; this information is then utilized to direct the retrieval of relevant data from the actual sources, which are stored in data lake 221 as illustrated. This separation of data source information from the actual data enhances the system's flexibility and scalability, allowing it to adapt to changes in data sources or organizational structures without requiring significant modifications to the core system architecture.

Employee type element 212 may define distinct worker classifications: worker type 1 (W1), worker type 2 (W2), and worker type 3 (W3), representing the primary cohorts for system analysis. Merley by way of example, W1 designates professional workers, W2 designates frontline workers, and W3 designates executive workers.

Feature type and toggle element 213 may depict he categorical structure of data features within system 200. Merley by way of example, the feature types include three primary classifications: interval, ordinal, and categorical, enabling appropriate processing and analysis methodologies for different types of data (e.g., salary information, tenure, location information, etc.).

Club label element 214 implements a methodology for feature value aggregation and categorization that addresses two challenges in machine learning model training: high-dimensional feature spaces and potential bias from small, unique groups in the dataset. This element defines how specific features are grouped and processed within their respective classification contexts, enabling more balanced model training while reducing feature dimensionality.

In some embodiments, club labeling is used to organize features by their applicability to different worker types. Features (F1, F2, . . . , Fn) are sorted and grouped based on their relevance to each worker type, creating distinct feature sets for different worker classifications. For example, in employee attrition prediction, club labeling is applied to process performance metrics that have different distributions across employee populations. Employee types—such as executives, professionals, and frontline workers—each have different performance evaluation metrics. Project success rates for executives may be measured quarterly across major business initiatives, while frontline workers'performance may be tracked daily through customer satisfaction scores and task completion rates. These distinct measurement frequencies and scales, if treated individually, may lead to a high-dimensional feature vector and potentially skew the model due to the relatively small population of certain employee types, such as executives.

Through club labeling, these performance metrics are processed within their respective worker type contexts, maintaining their natural measurement scales and frequencies while ensuring balanced representation in the model. For instance, executive performance patterns, despite being measured less frequently and across a smaller population, maintain appropriate weight in the model alongside the more numerous but differently-scaled performance metrics of frontline workers. This club labeling process preserves the authentic characteristics of each employee group's performance measurements while creating a balanced representation in the model, thereby enhancing its predictive accuracy across diverse employee types.

Ordinal rank element 215 specifies a ranking system for categorical data that needs ordered relationships. In machine learning applications, ordinal rankings establish meaningful sequential relationships between categorical values. For example, while colors such as red, green, and yellow may have no inherent ordinal relationship, in the context of traffic signals, they can be assigned meaningful ordinal values: red as “1”, yellow as “2”, and green as “3.”

Model list element 216 maintains a set of v distinct models (M₁, . . . , Mv). System 200 implements model performance evaluation capabilities to identify high-performing models in a use case or with respect to a training dataset. During the training process, multiple models are trained and evaluated based on a training dataset to optimize desired outcomes and prediction accuracy, enabling comprehensive model evaluation and selection.

Configuration component 210, or a portion thereof including one or more of data source element 211, employee type element 212, feature type and toggle element 213, club label element 214, ordinal rank element 215, and/or model list element 216 may reside on distributed storage environments for scalability, allowing large organizations to store and manage a variety of configurations for different business units, regions, or specific employee cohorts. Data replication and backup processes may also be employed to ensure data redundancy and availability, preventing loss of configurations due to hardware failure or system crashes.

By establishing configuration component 210, or a portion thereof including one or more of data source element 211, employee type element 212, feature type and toggle element 213, club label element 214, ordinal rank element 215, and/or model list element 216 within this hardware and software system, the system 200 may achieve a high degree of flexibility, scalability, and performance, allowing for rapid configuration changes, real-time data processing, and the efficient execution of predictive models tailored to specific organizational needs.

The configuration component 210 may include or be operably coupled to a configuration management module including, e.g., an application programming interface (API) or a configuration service. The configuration management module may allow other components in system 200, such as data preparation component 220 and model processing component 230, to access and query configurations based on the needs of a given process. When executing specific tasks—such as data preprocessing, feature engineering, or model training—the configuration management module retrieves relevant configurations from the storage system. These configurations include: data source specifications from data source element 211, employee type classifications from employee type element 212, feature types and toggles from feature type and toggle element 213, club labels from club label element 214, ordinal ranks from ordinal rank element 215, and model specifications from model list element 216.

In some embodiments, the configurations (or referred to as specifications) may be compiled as one or more configuration files, establishing a unified framework for automated retrieval and processing of multiple (e.g., heterogeneous) data sources for generating and use of machine learning models. The one or more configuration files serve as central control documents that define the operational parameters for data retrieval, processing and model training. A configuration file may specify multiple aspects of a system operation, including: data source location and access protocols, data validation rules, preprocessing operations, feature extraction methods, and model training parameters. For example, a configuration file may define which data fields to retrieve from each data source, how to handle missing values, what transformations to apply to specific features, and which model architectures to use for training.

The configuration file(s) include specifications for guiding multiple aspects of a system operation, including operations of data preparation component 220, model processing component 230, and model output component 240. The configuration file(s) include data source information to guide data pipeline element 222 in data retrieval from data lake 221, and parameters for subsequent data preparation in data integration and preparation element 223 of the data preparation component 220. The configuration file(s) also provide initialization and training parameters for machine learning models in model processing component 230, including model architecture, hyperparameters, and evaluation criteria for the model processing component 230. The configuration file(s) may further include information to guide output and/or presentation of model results for the model output component 240.

In some embodiments, system 200 provides a configuration interface through which users can specify data processing parameters. Through this interface, a user defines configuration parameters for configuration component 210 by inputting specifications for data sources, cohorts, features, ordinal rankings, and/or club labels as further described below for illustration purposes.

Data Source Configuration (data source element 211): a user specifies one or more data sources such as HR applications, databases, and file repositories. Accordingly, data source element 211 records in the configuration file(s) source locations and contained data types, including employee records, compensation data, demographics, and employment history.

Cohort Definition (employee type element 212): a user defines distinct cohorts based on employee characteristics (e.g., “Worker Type 1,” “Worker Type 2”). Accordingly, employee type element 212 records in the configuration file(s) mapping of source data to appropriate cohorts, enabling cohort-specific data processing.

Feature Characterization (feature type and toggle element 213): a user categorizes extracted features as numerical, categorical, or other types, and specify feature relevance for predictive modeling. Accordingly, feature type and toggle element 213 records in the configuration file(s) source these specifications for downstream processing.

Club Label Configuration (club label element 214): a user defines club labeling rules for data point grouping. For example, geographic data points may be grouped hierarchically (e.g., suburbs grouped under state designations). Accordingly, club label element 214 records in the configuration file(s) the defined club labeling rules. These specifications enable data aggregation at appropriate contextual levels.

Ordinal Ranking Configuration (ordinal rank element 215): a user assigns ranks to categorical variables through the user interface. For features identified as ordinal (e.g., hierarchical job titles), ordinal rank element 215 records in the configuration file(s) source ranking definitions assigned by the user.

In some embodiments, to enhance efficiency, the configuration management module may cache frequently accessed configurations in a memory buffer, reducing retrieval time from the primary storage. This may ensure that as system 200 iterates over different employee types (e.g., decision box 217) or model variations (e.g., decision box 218), the established configurations may be readily available for execution. Furthermore, when a new configuration file is defined or an existing configuration is updated, the configuration management module may write these changes back to the storage system, ensuring consistency across multiple system components.

The configuration management module (or another portion of the software environment) responsible for handling configuration component 210 may store and manage the configuration file(s) with version control mechanisms to track changes, allowing for seamless updates, rollback, and auditing of the configurations, which may maintain the integrity of the data retrieval, data preparation, and/or machine learning pipeline. The version control may be part of the configuration management module or software environment that stores metadata about configuration file(s) or a portion thereof (e.g., data source configuration, ordinal ranking configuration, etc., of a configuration file), such as the creation date, last modified date, and the user or system module responsible for the change. This version-controlled storage may be implemented using data memory 770 within storage memory 908 of device 700.

The configuration file(s) generated at configuration component 210 establish automated data retrieval and processing workflows through multiple functionalities including data preparation component 220. In some embodiments, the data preparation component 220 includes various elements including data lake 221, data pipeline element 222, data integration and preparation element 223, feature engineering element 224, and feature vectorization element 225, discussed in further detail below.

For configuration-based data retrieval, data pipeline element 222 uses the specifications to identify and access relevant data sources, file locations, and database tables from data lake 221. For example, data pipeline element 222 retrieves specified data according to defined column, table, or file parameters. System 200 may manage connections to the data sources, ensuring secure and accurate data retrieval.

In some embodiments, data lake 221 is configured to store a wide range of structured, semi-structured, and unstructured data. This storage can include relational databases, flat files (e.g., CSV, JSON), or non-relational datasets (e.g., NoSQL databases). Data lake 221 may serve as a centralized repository where raw data from various sources (e.g., HR systems, payroll databases, CRM systems) is stored, allowing data pipeline element 222 to access and extract the relevant data based on the configuration established in one or more configuration file(s) at the configuration component 210.

Data lake 221 may include a distributed storage system that includes one or more physical or virtual servers, storage arrays, or cloud-based storage resources designed for high-capacity data storage and fast retrieval. These storage systems may utilize storage devices such as hard disk drives (HDDs), solid-state drives (SSDs), or a combination thereof to provide both large storage capacity and quick access times. The data lake may be accessible over a network, such as a local area network (LAN), wide area network (WAN), or through cloud infrastructure, enabling the data pipeline to retrieve data from multiple physical locations as necessary.

In some embodiments, data pipeline element 222 may be composed of hardware processors and associated memory components configured to execute software instructions that facilitate data retrieval. For example, data pipeline element 222 is implemented as software components, hardware modules, or a combination thereof, configured to automate data retrieval from data lake 221, or another data storage system. Data pipeline element 222 can include network interface cards (NICs) for connectivity to data lake 221, as well as application programming interfaces (APIs) or query languages (e.g., SQL, RESTful services) for accessing and manipulating the data stored in the data lake. Upon reading from a configuration file that specifies the data requirements (such as data sources, employee types, and feature characteristics), data pipeline element 222 may initiate a series of retrieval operations to pull the data from data lake 221 or other data sources. The configuration may include access credentials, query parameters, and data format specifications needed to access and retrieve the data efficiently. Data pipeline element 222 may be configured to parse the configuration and dynamically construct queries that target the specific data required for each employee type. For example, if the configuration specifies that the data for employee type “W1” should include salary information, home address, and job role, the data pipeline generates queries that extract these specific attributes from data lake 221. The data pipeline may also utilize parallel processing techniques to issue multiple data retrieval requests concurrently, reducing the overall time required to pull data for multiple employee types.

Examples of data retrieved from data lake 221 can include, but are not limited to, salary information, home and office addresses, and employee type and role. For instance, data pipeline element 222 may retrieve salary records, including details of historical salary changes, bonuses, and other compensation-related data. Such information can be useful for understanding patterns of remuneration that may correlate with employee attrition. Additionally, data related to an employee's home and office addresses may be extracted, allowing the system to analyze potential geographical factors influencing attrition, such as commuting distance or office location. This geographical data may be useful when considering how an employee's residential location affects their work experience and turnover risk. System 200 can also obtain data specifying the type of employee, such as whether they are categorized as a professional, frontline worker, or executive. Furthermore, it may extract hierarchical role information within the organization, for example, identifying whether an employee is an associate, senior engineer, or director. This data may be relevant for cohort analysis and feature engineering, as it enables system 200 to categorize and analyze employees based on their roles and responsibilities, providing a structured framework for predictive modeling.

There may be multiple dimensions to an employer and an employee. Following retrieval, system 200 performs data mapping and cohort allocation based on configuration parameters. This process categorizes retrieved data into defined cohorts (or referred to as groups) by evaluating data attributes for cohort assignment (e.g., different employee types). System 200 processes and maintains separate data subsets for each cohort to enable context-specific model training. To this end, decision box 217 may analyze each of the employee types defined in the configuration file(s). In some embodiments, this analysis of the defined employee types is performed in parallel rather than sequentially. Such parallel processing may improve system efficiency, allowing multiple employee types to be processed simultaneously.

For example, decision box 217 checks for each employee type (e.g., W1, W2, . . . , Ww) as defined in the configuration file(s) and determines how much and/or which of the data retrieved from data lake 221 is applicable to each type. For example, for W1 (e.g., professional employees), system 200 may validate that the retrieved data contains the relevant fields specified in the configuration file(s), such as work experience and skills. For W2 (e.g., frontline employees), the data may focus on shift schedules, overtime records, or other job-specific metrics. For each employee type, system 200 creates separate chunks of data that are filtered and validated for relevance to that particular type. For example, for W1 (e.g., professionals), data pipeline element 222 may pull data related to roles requiring a certain level of education, responsibilities, and decision-making authority; for W2 (e.g., frontline workers), the data pulled may be more operational, covering areas such as shift patterns, location-based assignments, or production metrics. These data chunks can then be processed, e.g., in parallel through the data preparation process (e.g., at data integration and preparation element 223, feature engineering element 224, feature vectorization element 225) to form structured datasets suitable for training machine learning models as defined by the configuration. The parallel processing of each employee type allows system 200 to efficiently handle large volumes of data, accommodating the complex and multidimensional nature of employer-employee relationships, ultimately preparing the data for feature engineering and subsequent model training.

After the data is pulled and categorized according to employee types, system 200 may proceed to merge and process the data at data integration and preparation element 223. This processing element may function to handle the merging of data from multiple sources, such as data lake 221, to create a unified dataset that is suitable for downstream operations, including, e.g., machine learning operations. For example, system 200 may identify that one table contains salary data, while another contains personal details such as first and last names. Data integration and preparation element 223 may systematically align and join such data tables based on common keys or identifiers, such as employee IDs, to produce a comprehensive, consolidated dataset.

In some embodiments, data integration and preparation element 223 may also detect missing data, which may involve scanning for null entries in any of the data attributes (e.g., an employee's home or office address). Upon identifying missing data, data integration and preparation element 223 can implement one or more imputation strategies based on configuration rules specified in the configuration file(s) to handle these gaps. The importance of a feature may be determined through analysis of prior model performance by SHAP element 236 and SHAP composer 237, which evaluate how each feature contributes to model predictions. Features identified as having stronger influence on prediction accuracy may be subject to more sophisticated imputation strategies. For example, missing salary fields may be imputed or excluded based on predefined rules in the relevant specifications. The imputation strategies may be selected based on the type and significance of the missing data. For data fields that are not critical to model performance, data integration and preparation element 223 may remove rows or columns containing missing values. For important features where removal would significantly impact model performance, data integration and preparation element 223 may implement statistical imputation methods. These methods may include calculating and using statistical measures of the feature values in the retrieved data, such as mean, median, or mode, to fill missing values. For numerical features like salary data, data integration and preparation element 223 may use mean or median values computed from similar data groups (e.g., same job role or department). For categorical features, data integration and preparation element 223 may use mode (most frequent value) or predetermined logic specified within the configuration file(s). The specific statistical measure used for imputation may be defined in the configuration file(s) based on data characteristics and business requirements. In some cases, data integration and preparation element 223 may employ more sophisticated imputation strategies such as using the statistical distribution of the feature values or considering correlations between features when determining appropriate values for imputation. This preprocessing step may allow that the dataset is clean, complete, and accurately represents the relevant features required for training the machine learning models.

After data integration and preparation are complete, the processed data may be forwarded to feature engineering element 224. The feature engineering element 224 may transform the data into formats suitable for model training, leveraging configurations defined at feature type and toggle element 213. In some embodiments, system 200 categorizes data into three primary types: interval, ordinal, and categorical. Interval data refers to numerical values that may be analyzed directly, such as age, years of service, or salary. Ordinal data captures ranked values, allowing system 200 to define hierarchical relationships between features (e.g., senior engineer, associate, director). Categorical data may include discrete values that do not have a particular order or ranking, such as assigning “1” to red, “2” to yellow, and “3” to green.

During the feature engineering process, feature engineering element 224 may pull definitions and rankings specified in the configuration file(s), e.g., from the portion defined by feature type and toggle element 213, to ensure accurate interpretation of each data type. Feature engineering element 224 can then create new derived features by combining or transforming existing features based on contextual rules defined within the configuration file(s). For example, feature engineering element 224 can derive new metrics, such as counting the number of promotions an employee received within a certain period. Furthermore, feature engineering element 224 may consider the effect of such promotions on team dynamics, assessing whether one individual's promotion may influence another team member's likelihood of staying with the organization. By enriching the data with new, relevant features, feature engineering element 224 may enable system 200 to provide a more nuanced and contextualized understanding of employee behavior, ultimately enhancing the predictive capability of the machine learning models. These engineered features may serve to make the data more representative of the factors affecting an employee's attrition risk, thereby improving the accuracy and reliability of the predictive model.

In some embodiments, after feature engineering is completed, system 200 may proceed to perform a process known as club labeling, which can be executed by feature engineering element 224. This club labeling can be performed based on criteria set out in the club label configurations defined by club label element 214. Club labeling or determining a club label may be a technique to manage and group data points by identifying associations, cohorts, or groups that are useful for the machine learning model to understand employee behavior. For example, employees under “Club Colorado” may be subject to state-level regulations that differ from those in “Club Englewood, Colorado,” which pertains to more localized conditions. This process can help to group data at higher levels (e.g., state level) rather than more granular ones (e.g., suburb level), thereby providing the machine learning model with data that can help improve generalization and reduce noise.

Club labeling may reduce the dimensionality of categorical data, which in turn may improve the machine's ability to identify patterns. For instance, in an organization, most employees may earn between $100,000 and $200,000, but a small subset, such as the CEO or top executives, may earn significantly more. This wide variation in salaries may make it difficult for a machine learning model to effectively learn patterns. Therefore, the club labeling process may organize data into broader bands, such as a “lower band” for employees earning between $100,000 and $200,000 and a “higher band” for those earning substantially more. This grouping into bands or “clubs” may help the machine learning model to avoid overfitting to outliers or creating excessive variables for small subcategories, allowing the model to focus on more generalizable trends. By reducing the number of categorical variables or features, system 200 may achieve a lower dimensionality within the dataset, which can be useful for training machine learning models. As a result, the dimensionality reduction brought about by club labeling may lead to a more efficient and effective learning process, as the machine learning model is provided with a dataset that has fewer variables but is still representative of underlying patterns.

After the club labeling process is completed, control can pass to the feature vectorization element 225. Feature vectorization element 225 may convert processed data into numerical vectors suitable for machine learning algorithms. Machine learning models operate based on mathematical functions or formulas, which require data in numerical form. Thus, vectorization can transform all forms of data—whether text, categorical values, or ordinal ranks—into numbers that the model can interpret. The feature vectorization process may involve merging data produced from feature engineering with ordinal rankings (e.g., ordinal rank element 215) to preserve the inherent order or hierarchy of certain features. For example, ordinal data such as job titles (e.g., associate, manager, director) may be represented as ranked values, reflecting their hierarchical relationships. Feature vectorization element 225 may apply weights to these ordinal data points to maintain the relative significance of these ranks when constructing the numerical vectors. For instance, the ordinal ranks assigned to job titles may have greater importance than other categorical variables, influencing how the model interprets and learns from the data. The process of vectorizing features can also apply to textual data, which is converted into a numerical format that a machine learning algorithm can process. For example, if certain features are represented as text strings (e.g., department names, geographical regions), these strings can be mapped to corresponding numerical values. Feature vectorization element 225 effectively prepares and formats all processed features and engineered data into vectors that can be ingested by machine learning models, allowing the models to learn and generalize from the data more efficiently.

After the feature vectorization is completed, control may pass to the model processing phase at model processing component 230, through decision box 218. System 200 may support processing of multiple machine learning models, as defined in model list element 216, allowing for the execution of different algorithms and parameters for the models. For example, the model list in the configuration file(s) defined by model list element 216 may include linear or logistic regression models, decision tree models, random forest models, and XGBoost models. Each model in the model list may be associated with a set of parameters and hyperparameters specified at model list element 216. For instance, a decision tree model may have parameters such as the depth of the tree (defining the number of branching levels), breadth of the tree (defining the number of child nodes per parent node), and cardinality (specifying the range of values a node can take). The system may employ Randomized Cross-Validation (RandomCV) method for parameter optimization, enabling parallel processing for enhanced computational efficiency. Merely by way of example, logistic regression models may achieve optimal performance metrics, with accuracy of 85%, precision of 84%, and recall of 85%. The model list element 216 may specify which models to execute and with what parameters. In some embodiments, a user may specify or provide criteria to select one or more models and/or model parameters.

Decision box 218 may pair the respective models and the relevant input from the feature vectorization element 225 and pass the pairs to model processing component 230 to execute machine learning processes.

Data prepared by data preparation component 220 may be used for multiple purposes, including model training, testing, validation, or for making predictions for one or multiple employees using one or more trained models. The data preparation workflow may remain substantially consistent across these purposes to achieve uniform processing and reliable results. This consistency may be achieved through the configuration file(s), which establish standardized procedures for data retrieval, processing, and feature engineering regardless of the intended use of the prepared data. More specifically, data preparation component 220 may prepare data based on the configuration file(s) generated at configuration component 210. By using the configuration-driven preparation process, system 200 may ensure that predictions made by trained models are based on data processed in substantially the same manner as their training data, thereby maintaining prediction accuracy and reliability. Additionally, the standardized procedures defined in the configuration file(s) may enable the system to process data from different sources having different formats, data structures, or information types, allowing such data to be properly transformed for use within the system for a desired use case.

Model processing component 230 may include elements such as a machine learning element 231, a result publication element 232, a result validation element 233, a top performing model list element 234, an ensemble element 235, a SHAP (SHapley Additive exPlanations) element 236, and a SHAP composer 237. These elements may form a workflow for model training, evaluation, refinement, and application, providing a robust pipeline for both predictive model development and deployment.

For model development, machine learning element 231 may process the vectorized data to learn patterns based on respective parameters and configurations defined in model list element 216. The models identified in the configuration file(s) may include various machine learning algorithms, such as logistic or linear regression models, decision tree models, or other methods specified by the user or system administrator. During training, the models may learn relationships and correlations within the data, optimizing for predictive accuracy and other performance metrics (e.g., precision, recall). In some embodiments, machine learning element 231 may initiate training for multiple models in parallel, enabling efficient pattern learning across the vectorized data.

Machine learning element 231 may perform different functions depending on the intended use case. During model development, machine learning element 231 may train models using vectorized data based on parameters and configurations defined in the configuration file(s) as already described. During model application, machine learning element 231 may apply one or more trained models to generate predictions using new vectorized data prepared from current information (e.g., information of one or multiple employees for whom attrition risk is to be assessed) according to, e.g., the same or similar configuration file(s), or a portion thereof. In both cases, results from machine learning element 231 may be further processed by other elements of model processing component 230.

During model development, after machine learning element 231 completes a training phase, result publication element 232 may publish performance metrics for each model. These metrics may include accuracy, precision, recall, and other relevant indicators of predictive or classification capability. For example, model A may report metrics indicating its pattern learning effectiveness, with specific values for accuracy, precision, and recall, while model B may report different metrics based on its underlying algorithm and parameter settings. Result publication element 232 may aggregate these metrics and make them available through a dashboard or results board for analysis. During model application, result publication element 232 may publish prediction results and associated confidence metrics from machine learning element 231.

During model development, result validation element 233 may evaluate each model's performance by comparing the published metrics. A key aspect of this validation involves comparing performance between training and testing datasets to identify potential issues. For instance, if a model achieves 90% accuracy on training data but only 70% on testing data, this disparity may indicate overfitting—where the model excels on familiar data but fails to generalize to unseen data. Result validation element 233 may identify such overfitting or underfitting issues and work to minimize the performance gap while maintaining high overall accuracy. During model application, result validation element 233 may evaluate prediction confidence metrics and validate that predictions fall within expected ranges based on historical patterns.

In some embodiments, once model validation is complete, model processing component 230 may select a subset of models for further processing. For example, models that achieve top performance metrics may be listed in a top performing model list by top performing model list element 234. Ensemble element 235 may then process results from these models.

During model development, ensemble element 235 may implement techniques that involve training multiple models. For example, ensemble element 235 may utilize bagging-based techniques, incorporating bootstrap aggregating where models are trained on different data subsets. This approach may include random forest-style aggregation where models are trained on random feature subsets, and may leverage out-of-bag estimates to weight model contributions. Ensemble element 235 may also implement boosting-based techniques, involving sequential model training where subsequent models focus on previous models' errors. This approach may include adaptive weighting of training samples based on prediction difficulty and may incorporate gradient boosting approaches for optimizing the ensemble. Additionally, ensemble element 235 may train meta-models, also referred to as “stackers,” using algorithms such as linear or logistic regression, gradient boosted trees, or neural networks, which may be implemented in multiple hierarchical layers to optimize the combination of predictions.

During model application, ensemble element 235 may combine predictions from multiple trained models using various techniques. These techniques may include weighted averaging, where model-specific weights may be determined based on various factors such as validation performance metrics (e.g., accuracy, AUC-ROC, or F1-score), cross-validation stability scores, model confidence scores, or weights optimized through computational methods such as grid search or Bayesian optimization. For classification tasks (e.g., tasks involving assigning one or multiple employees to one of multiple predefined groups, such as high risk, medium risk, and/or low risk groups), ensemble element 235 may implement voting mechanisms. These mechanisms may include hard voting (where each model casts a binary vote and the majority prediction is selected), soft voting (where probability predictions are averaged and thresholded), or weighted voting (where votes are weighted by model confidence or historical performance). Additionally, ensemble element 235 may apply meta-models trained during the model development phase to combine predictions in a stacking approach.

In both training and application phases, ensemble element 235 may dynamically select which models to include based on correlation analysis of model predictions to achieve diversity, time-based performance metrics, resource utilization constraints, prediction confidence thresholds, or the like, or a combination thereof. For example, if a first model predicts a 70% chance of an employee leaving and a second model predicts a 50% chance, ensemble element 235 may apply model-specific weights (e.g., 0.6 and 0.4 based on validation performance) to calculate a weighted prediction of (0.6×70%)+(0.4×50%)=62%. This prediction may be further calibrated using historical data patterns and may incorporate confidence intervals or uncertainty estimates.

Ensemble element 235 may implement adaptive techniques where the specific ensemble method is automatically adjusted based on historical performance patterns, input data characteristics, computational resource availability, and real-time feedback on prediction accuracy. Multiple ensemble strategies may be maintained and dynamically selected or combined based on contextual factors, prediction urgency, or accuracy requirements for specific use cases.

SHAP element 236 and SHAP composer 237 may also serve different purposes during model training versus model application. During training, these elements may analyze how features contribute to model predictions to guide feature selection, model refinement, and determination of ensemble weights. For example, analysis may reveal whether certain features consistently have strong influence across multiple models, providing insights for feature engineering or model selection.

During model application, SHAP element 236 may evaluate individual feature contributions for specific predictions, while SHAP composer 237 aggregates and composes these explanations into a human-readable format. For example, when predicting an employee's likelihood of leaving, the analysis may reveal whether salary information or department more heavily influences the prediction for that specific case. This ensures transparency in the decision-making process by allowing users to understand the key factors driving each prediction.

By integrating these elements of model processing component 230, system 200 can validate the results of each model, combine top-performing models through an ensemble technique, and explain model decisions through SHAP. This comprehensive approach allows for efficient training, validation, and interpretation of machine learning models, ultimately enhancing the predictive capabilities of the system while providing transparency into how predictions are made. The automated nature of this pipeline—from model training to validation, ensembling, and explainability—reduces the need for manual intervention and can facilitate faster, more accurate, and more understandable predictive modeling.

During model development, a model meeting performance criteria may be serialized by machine learning element 231 and saved using various storage formats suitable for machine learning models. The configuration management module may manage the storage of these models in various formats, including binary serialization formats such as pickle files in Python and joblib files for scikit-learn models. For interoperability between different frameworks and platforms, model processing component 230 may store models in standardized formats such as ONNX (Open Neural Network Exchange) format or protocol buffers. For models with complex structures and large parameter sets, the configuration management module may utilize HDF5 (Hierarchical Data Format) files, while models with simpler architectures may be stored using JSON or YAML structured files. Various machine learning frameworks integrated within machine learning element 231 also provide their own specialized storage formats, such as SavedModel format for TensorFlow models or PTH files for PyTorch models.

The serialization process performed by machine learning element 231 transforms the model objects (including their trained parameters, weights, and structure) into a storable format. When these models are needed for real-time predictions, the configuration management module first identifies and retrieves the relevant model files, and machine learning element 231 deserializes them—that is, loads them from the stored files and reconstructs them back into functional model objects that can process new data and generate predictions. This serialization-deserialization process, coordinated between the configuration management module and machine learning element 231, enables efficient storage and retrieval of trained models for real-time applications.

In some embodiments, model output component 240 of system 200 may provide the final output of one or more trained models generated from the model generation processes (e.g., at model processing component 230). The model output component 240 may include various subcomponents to deliver predictive results and insights, such as an application interface (app 241) and a monitoring element (monitoring element 242). These subcomponents may interact with the trained models to present the results to a user and facilitate ongoing model evaluation, refinement, and visualization based on certain input data provided by, e.g., a user.

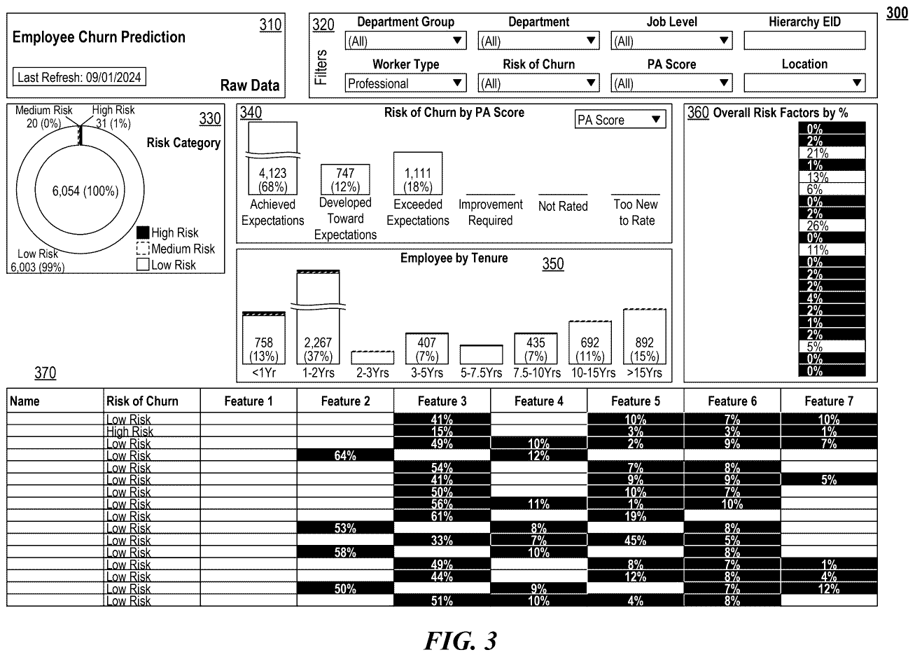

The application interface (e.g., app 241) may be configured to present a user with the output of the machine learning models in a user-friendly and interactive format (e.g., an exemplary GUI illustrated in FIG. 3 and described below). App 241 may receive predictive results from ensemble element 235 or from individual top-performing models, depending on how system 200 aggregates the model outputs. The results may include a variety of outputs, such as risk scores, predictions (e.g., likelihood of employee attrition), probabilities, and interpretative data that model processing component 230 has generated. The interface can display these results through dashboards, charts, or visual analytics that may allow users to easily comprehend the predictive insights.

A user may interact with app 241 in various ways to explore and analyze model predictions. For example, the user may input specific data or parameters (e.g., employee details, company metrics) to generate updated predictions or to filter the presented results based on certain criteria. App 241 may present performance metrics, such as model accuracy, precision, recall, and other validation scores, allowing users to understand the efficacy of each model and how the ensemble predictions were derived. If model explanations have been generated using SHAP or other explainability techniques (e.g., from SHAP element 236 and SHAP composer 237), app 241 can provide visual breakdowns of feature importance or contribution to the overall predictions. For example, the user can see how salary, department, or location contributed to an employee's likelihood of attrition. The user may compare results across multiple models, including individual predictions from top-performing models (e.g., identified by top performing model list element 234) and the aggregated predictions from the ensemble element (e.g., determined by ensemble element 235). In some embodiments, app 241 may support real-time interaction, allowing the user to modify input data and immediately (essentially in real-time) see how these changes affect the predictive outputs, offering flexibility and responsiveness for decision-making processes.

Monitoring element 242 may be designed to provide ongoing surveillance and assessment of the models' performance. Monitoring element 242 may track the accuracy, stability, and relevance of model predictions over time, particularly as new data is ingested into the system. This element can play a crucial role in ensuring that the models remain effective and aligned with real-world scenarios, as data distributions and business contexts may change over time. For example, monitoring element 242 may continuously track key performance indicators (KPIs) of the models, such as precision, recall, F1 scores, and other relevant metrics. These performance measures may be compared against predefined thresholds or baselines to ensure models are consistently meeting expected accuracy levels. Monitoring element 242 may also detect deviations or anomalies in model outputs, such as sudden drops in accuracy or emerging biases in predictions. Upon identifying an anomaly, monitoring element 242 may generate alerts to notify users and/or trigger automated retraining processes to recalibrate the affected models. A user may provide feedback directly through monitoring element 242 based on the outcomes and predictions presented in app 241. For instance, if the user determines that a prediction is incorrect or misaligned with expectations, this feedback can be logged and used to adjust or retrain the model, improving its performance over time. Monitoring element 242 may also provide visualizations and insights into model drift, helping the user understand how model performance changes as new data is introduced, and offering recommendations for corrective actions if the model's efficacy declines.

A user may engage with model output component 240 primarily through app 241 to explore model results and predictions, as well as through monitoring element 242 to oversee model health and performance. For example, the user can input query data or variables into app 241, which may then prompt the trained models to generate updated predictions based on the provided input. The model's predictions and explanations are presented within app 241, allowing users to explore and interpret the results. Users can filter, sort, or visualize these results based on relevant business needs or decision criteria. Monitoring element 242 may continuously evaluate model performance based on real-time data and user feedback. If any degradation in model performance is detected, monitoring element 242 may recommend corrective actions or initiate retraining to ensure continued model accuracy. A user may also submit feedback on the model's predictions through app 241 or directly into monitoring element 242. This feedback is processed to refine model behavior, improve accuracy, and ensure that the predictive insights remain relevant and actionable.

In some embodiments, system 200 may be configured to generate and display alerts for certain employees who exhibit an attrition risk (or referred to as a churn risk) greater than a predetermined threshold (via, e.g., app 241). The threshold may be a user-defined value or set by default within system 200 to identify employees whose predicted likelihood of leaving the organization exceeds a specified risk level. In some embodiments, system 200 may automatically determine the threshold by analyzing historical data that includes both model-predicted attrition risks and actual attrition outcomes of employees. For example, system 200 may optimize the threshold value by evaluating various threshold levels against historical prediction-outcome pairs to maximize prediction accuracy metrics such as precision, recall, or F1-score.

System 200 may analyze the model output (e.g., from machine learning element 231 or ensemble element 235) and compare the predicted attrition risk for each employee against this threshold to determine whether an alert should be generated. Upon receiving model output data, system 200 may iterate through the predictions for individual employees and assess their respective churn risk scores. If an employee's predicted risk is greater than the predefined threshold, system 200 can automatically flag that employee as at high risk of attrition. For example, if the threshold is set at 50%, system 200 may generate an alert for any employee whose churn risk score exceeds 50%. The comparison between each employee's churn risk and the threshold allows system 200 to identify those who may require attention for potential retention strategies.

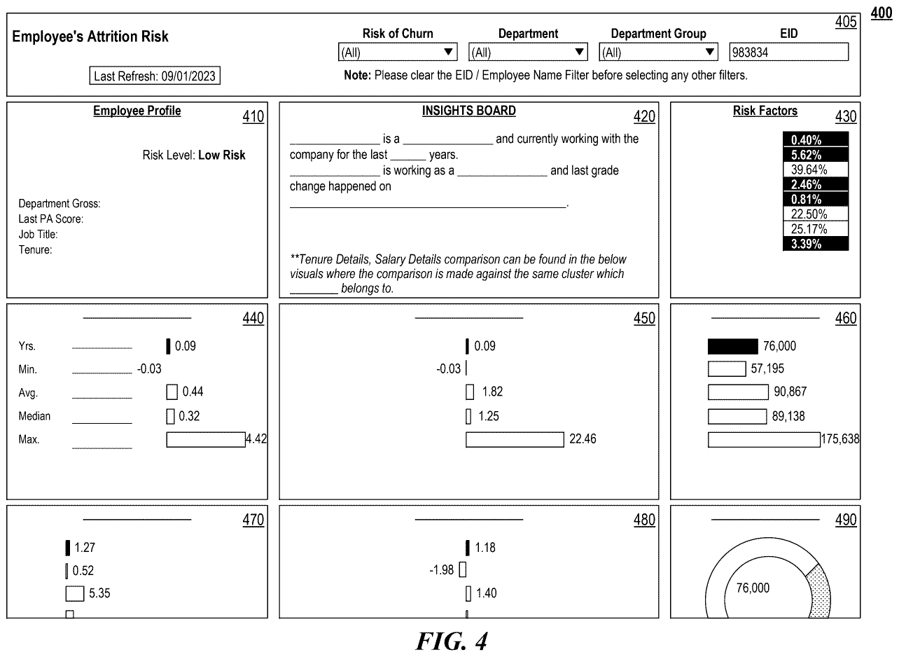

When an employee's churn risk is identified as exceeding the threshold, system 200 may proceed to generate an alert that highlights this potential risk via e.g., app 241. The alert can be displayed prominently within the GUI, either as a pop-up notification, a highlighted row in a table, or an additional indicator within a visual element like a chart or graph. For instance, in a GUI similar to FIG. 4, the system may add a colored indicator next to the employee's profile information, or in a GUI like FIG. 3, the alert may appear as an overlay on the risk category donut chart to emphasize high-risk employees.

Alternatively or additionally, system 200 may allow a user to interact with the GUI to specify additional parameters, such as department, job role, location, or other criteria that may affect which employees are assessed for alerts. When a user selects a specific parameter (e.g., choosing to view only employees within a particular department), system 200 may filter the model output accordingly and reevaluate the churn risk scores for the filtered subset of employees. If any of these employees' churn risk scores exceed the predetermined threshold, system 200 may then generate and display alerts specifically for this subset. For instance, if a user selects a department filter within the GUI to view all employees in the “Sales” department, system 200 may recalculate or retrieve the churn risk scores solely for those employees. If an employee within the Sales department has a churn risk score of 60%, and the threshold is 50%, system 200 may generate an alert specific to that employee, indicating their risk level is higher than acceptable for the selected parameter. The alert can include contextual details such as the employee's name, role, and exact churn risk percentage, enabling the user to understand the potential attrition risk within the context of the chosen parameters.

The alerts generated by system 200 may also serve as triggers for further actions. For example, upon displaying an alert, system 200 may provide additional options within the GUI for the user to explore more detailed insights related to the high-risk employee(s), such as viewing the factors contributing to their risk score or initiating retention measures. For example, information from SHAP element 236 and SHAP compose 237 may be included or taken into consideration for identifying the contributing factors. The alerts, therefore, act not only as a mechanism to identify potential churn risks but also as a prompt for users to take proactive steps based on the predictive insights provided by system 200.

Through this integrated process, model output component 240 may ensure that the predictions from the machine learning models are not only accessible and understandable to users via app 241 but also continuously validated and improved over time with the support of monitoring element 242. This approach may provide a comprehensive framework for predictive modeling, supporting both real-time decision-making and long-term model health.

FIG. 3 is a schematic diagram (e.g., a GUI) showing various results of employee churn prediction, according to some embodiments. GUI 300 may serve as an implementation of app 241, providing an interface where a system (e.g., system 200) can display the predictive insights and allow interaction based on model output from model processing component 230. GUI 300 may allow the system to effectively convey the results of predictive models to a user in an interactive manner, offering functionality to explore data, understand feature influences, and track model performance for informed decision-making. By dynamically responding to user input and maintaining updated visualizations, the system may provide a robust interface for exploring and managing employee churn predictions. GUI 300 may dynamically render various components to facilitate exploration and analysis of predictions, using intuitive visualizations and user input-driven controls. GUI 300 includes dashboard header 310 that contains the title “Employee Churn Prediction,” refresh date information, and source data being “Raw Data,” as illustrated.

In some embodiments, GUI 300 includes a filters section 320 configured to allow a user to interactively refine the data and predictions. Filters section 320 may include one or more dropdown filters to enable a user to select specific subsets of data and apply these selections to update the content displayed on GUI 300 accordingly. For example, GUI 300 may include various dropdown filters including Department Group, Department, Job Level, Worker Type, Risk of Churn, PA Score, Location, Hierarchy EID as illustrated. The system may present dropdown menus that allow a user to filter the data based on categories such as department groups, job levels, and locations within the organization. When a user makes a selection from one or more dropdowns (e.g., choosing a specific worker type or PA score), the system may receive the input and filter the data to reflect only the relevant subset, updating all associated visualizations and tables dynamically.

The central portion of GUI 300 may present visualizations summarizing and categorizing the risk of employee churn. As illustrated, the visualizations include section 330 showing a risk distribution overview, section 340 showing a performance assessment distribution, section 350 showing a tenure distribution, section 360 showing risk factor weights, and table 370 showing employee risk details. The system can generate and display these visualizations based on processed model output, updating them in real-time based on user-selected filters.

As shown in section 330, the system renders a donut chart to categorize employees by their predicted risk levels (e.g., Low Risk, Medium Risk, High Risk). The chart may be automatically populated with data reflecting the proportions of each risk category. For instance, upon receiving new data inputs or user-applied filters, the system may update the chart to display the corresponding total count and percentage for each risk level.

As illustrated in section 340, the system also generates a horizontal bar chart to categorize employees based on their Performance Appraisal (PA) scores, such as “Achieved Expectations” or “Exceeded Expectations.” The chart may be adjusted based on filter selections, and the system can update the visualization to correlate PA scores with predicted churn risk. A bar chart may display risk of churn based on employee tenure categories (e.g., <1 Year, 1-2 Years).

As illustrated in section 350, the system calculates and represents how tenure correlates with churn risk, dynamically refreshing the chart if user input or updated data modifies these relationships.

As illustrated in section 360, the system also generates a bar graph displaying Overall Risk Factors by % and highlights key variables that influence churn risk. Each bar may correspond to a feature from the model (e.g., salary, department), with the percentage representing the feature's relative weight in determining churn risk. The system may update this visualization to reflect feature contributions based on current filter settings or user queries. The results in section 360 may be from SHAP element 236 and/or SHAP composer 237.

The bottom section of GUI 300 may include a detailed table 370 providing individual predictions and feature-level insights for an employee. The system may populate this table 370 with predictions and model-specific features after processing the vectorized data from model generation (e.g., at model processing component 230). For each row in the table 370 representing an individual employee, the system may display columns showing the Risk of Churn (e.g., Low Risk, High Risk) and feature values that have influenced the model prediction. The system may update the rows dynamically based on user interactions, such as filtering by department or tenure. For an employee entry, the system may display how different features (e.g., Feature 1, Feature 2, . . . , Feature 7) contribute to the risk prediction. The table 370 may show percentages or numerical scores that indicate the significance of each feature in the prediction. If a user applies a filter or requests a different view, the system can recalculate and update these values accordingly.

GUI 300 may support real-time data updates and interactive user-driven functionality. The system may perform the following operations based on user input. For example, a timestamp (e.g., “Last Refresh: 09/01/2023”) may indicate the last time the data was refreshed. The system may provide a function to refresh the data on-demand or automatically based on pre-set conditions, ensuring that GUI 300 displays current predictions. When a user interacts with the filters or any visualization (e.g., drilling down into a specific risk category or selecting a PA score range), the system may update all relevant charts, graphs, and tables in real-time to reflect the changes.

The system may integrate various components to deliver the model outputs as depicted in GUI 300. For example, the predictions visualized in sections 330, 340, 350, and/or table 370 of GUI 300 may originate from trained machine learning models (e.g., machine learning element 231), specifically from top-performing models or ensemble outputs as determined by top performing model list element 234 and ensemble element 235. Feature contributions and explanations (e.g., overall risk factors displayed in section 360 and/or table 370) may be derived from SHAP element 236) and SHAP composer 237, enabling a user to understand how different features impact the model's churn predictions. Model monitoring (e.g., from monitoring element 242) may provide feedback on model performance over time, ensuring that predictions remain accurate, relevant, and reflective of changing data conditions.

FIG. 4 is a schematic diagram showing various results of an employee's attrition risk, according to some embodiments. This schematic diagram can be GUI 400 that may serve as part of the system's app component (e.g., app 241) and is designed to allow a user to review the predictions for a specific employee, such as their risk of attrition and the various factors contributing to this risk. GUI 400 may integrate outputs from the model generation processes at model processing component 230 and presents them in a clear, interactive format, allowing users to assess, interpret, and make decisions based on an employee's predicted likelihood of attrition. GUI 400 in FIG. 4 may be designed to facilitate the exploration and interpretation of individual-level predictions, with the system providing multiple visual and textual elements to support a user's understanding of the factors affecting an employee's attrition risk. The combination of profile summaries, insights, and comparative charts may allow for a comprehensive view of the predictive model's outputs, ensuring that users can make informed decisions based on the data presented.

As illustrated in FIG. 4, GUI 400 may include a filters section 405 (the top of GUI 400), where the system may provide dropdown filters and input fields to allow a user to specify parameters for viewing the data. For instance, the Risk of Churn, Department, and Department Group dropdown filters may enable the user to refine the dataset to view predictions for specific segments or groups within the organization. Additionally, a specific employee can be queried using the EID field, which allows for the direct input of an employee identification number (e.g., “983834”). When a user specifies an employee ID (EID), the system may fetch and display the predictive analytics and insights for that employee, overriding any broader filter selections. A note in section 405 advises the user to clear the EID filter before applying any other filters, ensuring that the correct subset of data is presented.

Employee profile section 410 is located on the left side of GUI 400 and provides a summary of key details for the selected employee. The system may display the risk level, which indicates the overall churn risk (e.g., “Low Risk”), along with additional data points such as Department Gross, Last PA Score, Job Title, and Tenure. These details give context to the employee's position within the organization and form the basis for further analysis. The system may update this profile in real-time as a user changes the selected employee or modifies filter criteria.

Adjacent to employee profile section 410 is insights board 420, a narrative-style summary generated by the system to highlight critical details about the employee's role, performance, and tenure. The system may populate text fields based on data retrieved from internal records and model predictions, presenting statements such as how long the employee has worked at the company, their job role, and the last time a grade change (e.g., promotion or demotion) occurred. This section provides a high-level overview to help a user quickly understand the background and current status of the employee.

To the right of insights board 420 is the risk factors section 430, which the system uses to display the breakdown of different factors contributing to the employee's attrition risk. The system may calculate and display these factors as percentages, with each percentage representing the weight or importance of a particular variable (e.g., salary, department, performance) in determining the employee's churn risk. This visualization provides transparency into the underlying model's decision-making process, helping a user understand which features are most influential in the risk assessment.

In the lower half of GUI 400, several graphical representations and bar charts visualize comparative metrics. For example, there may be multiple sections 440-490 showing comparisons across various attributes, such as Years of Service (Yrs.) in section 440, performance ratings, salary details in section 460, and other predictive factors. The system may display these values as ranges (e.g., Min, Avg, Median, Max), with vertical bars or boxes indicating the employee's position within the distribution of their cohort or peer group. For instance, a bar representing tenure may show how the employee's years of service compare to the average or maximum tenure within their job cluster. The system may use these visuals to highlight anomalies or to provide context for how an employee's characteristics align with or differ from organizational norms.

The system may present a variable that may contribute to an attrition risk prediction as horizontal bars. For example, in the salary details section 460, the length and shading of each bar represent the employee's standing relative to other employees or predefined benchmarks (e.g., average salary within the department). This helps a user quickly assess how the employee's salary compares to their peers and how this comparison may relate to their predicted churn risk.

A chart may be provided, as illustrated in the lower right corner of GUI 400, to offer a visual representation of specific metrics, such as salary relative to various benchmarks or groups. The system can dynamically update this chart based on the current filters and employee selection, providing a quick snapshot of where the employee stands in relation to the organization's wider distribution of values.

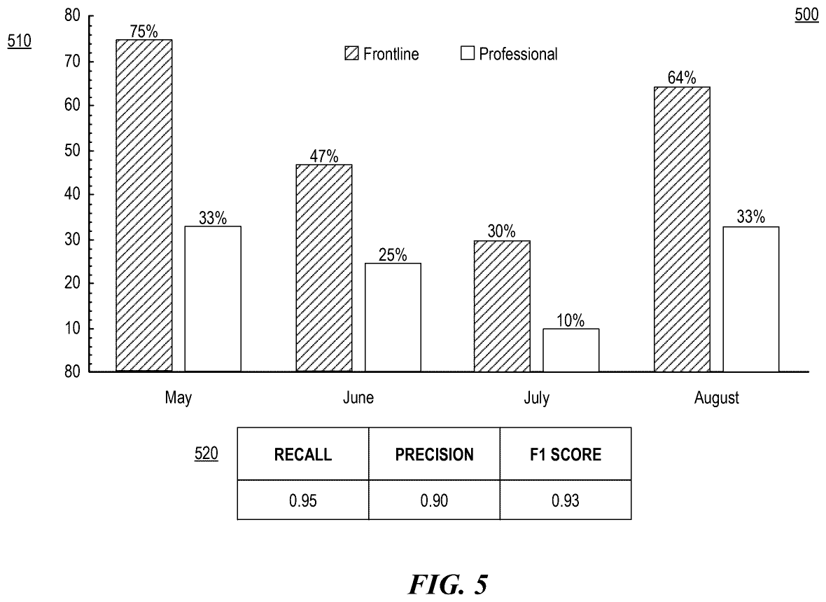

FIG. 5 depicts a GUI according to some embodiments. GUI 500 includes a bar chart 510 and a performance metrics table 520, which may be part of the system's app component (e.g., app 241) to provide insights into model predictions over time, segmented by employee type, and the corresponding performance metrics of the predictive model. GUI 500 may allow for user interactions that trigger the display of this visual data, and the system may dynamically generate these outputs based on user input or selections, such as specifying a particular time range or employee cohort.

Bar chart 510 visualizes the distribution of predictions over several months, grouped by employee type. Specifically, chart 510 represents the proportions of Frontline and Professional employees at risk of attrition, displayed as separate bars for each month. The system may populate this chart by processing the predictive outputs from the model processing component (e.g., model processing component 230) and filtering the results based on the selected employee categories. For example, the bars marked “Frontline” (hatched bars) and “Professional” (open bars) display the predicted attrition percentages for each month from May through August. The system may display the percentages on top of each bar for clarity (e.g., 75% for Frontline in May, 33% for Professional in the same month).

The Monthly Breakdown shows how the predicted risk levels for Frontline and Professional employees vary over time. For instance, in May, the system indicates a higher attrition risk for Frontline employees (75%) compared to Professional employees (33%). As the months progress, the system may adjust these values based on new data or updated model predictions, as seen by the variation in percentages across June, July, and August. This breakdown may allow a user to understand seasonal trends or other temporal patterns in employee attrition risk, providing insights for targeted interventions.

Beneath bar chart 510, GUI 500 displays performance metrics table 520, containing values for Recall, Precision, and F1 Score—key indicators of the predictive model's performance. These metrics may be derived from model validation (e.g., at result validation element 233) and represent the effectiveness of the model in identifying the correct predictions over time. As in this example, Recall (0.95) may indicate the proportion of actual positives (e.g., employees who are truly at risk of leaving) correctly identified by the model. Precision (0.90) may represent the proportion of predicted positives that are actual positives, reflecting the model's accuracy in making churn predictions. F1 Score (0.93) may be the harmonic mean of recall and precision, providing a balanced measure of the model's performance by accounting for both false positives and false negatives.

The system may update these performance metrics in real-time as new data is processed or as the model is refined, enabling continuous evaluation of predictive accuracy. These metrics can guide users in assessing the reliability and robustness of the model's predictions over the selected time period.

GUI 500 may support dynamic user interactions. For instance, if a user selects a different employee type, time frame, or performance metric from available filters or options, the system may adjust the bar chart and table values accordingly. The visual representation and the performance table are thus linked, providing a comprehensive overview of the model's predictions and its performance over time, segmented by employee cohorts, and can facilitate decision-making based on the observed trends and the quality of the model's predictions.

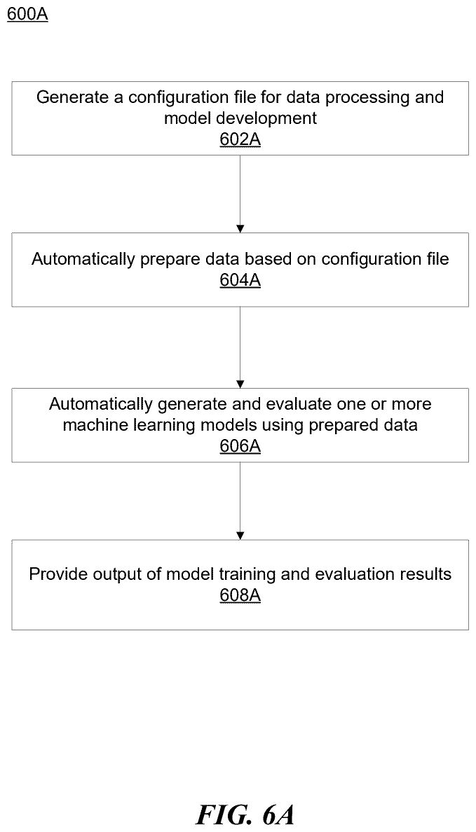

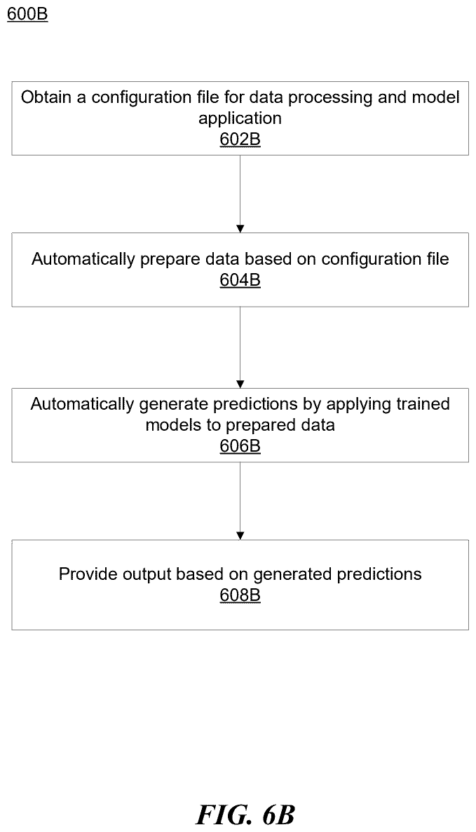

FIG. 6A is a flow diagram for a process 600A for developing machine learning models for employee attrition prediction, according to some embodiments. The operations of process 600A may be performed by components of system 200, as illustrated in FIG. 2. These operations are explained in greater detail below, where references to the corresponding components in FIG. 2 are provided. It should be appreciated that the process may include additional operations that are described above in connection to various components of system 200, and the operations may be executed by one or more hardware and software components of system 200.

At 602A, the system may generate one or more configuration files that guide data retrieval, data processing, and model development operations. Model development may include model training, testing, and/or validation. This operation may be performed by configuration component 210 of system 200. In some embodiments, through a configuration interface, users may specify various configuration parameters. Configuration component 210 may specify various parameters in the configuration file(s). The configuration file(s) may include data source information from data source element 211, including source locations and specifications for retrieving data from multiple data sources such as HR databases, employee records, and other organizational data repositories. The system may define in the configuration file(s) distinct worker classifications (e.g., professional workers, frontline workers, executive workers) through employee type element 212. The system may define in the configuration file(s) feature categorizations (e.g., interval, ordinal, categorical) for appropriate processing of each data type through feature type and toggle element 213. The system may implement club labeling through club label element 214 to address challenges in machine learning model development, such as organizing features by their applicability to different worker types and enabling balanced representation in the model. For features identified as ordinal, ordinal rank element 215 may record ranking definitions to establish meaningful sequential relationships between categorical values in the configuration file(s). Model list element 216 may maintain specifications for multiple machine learning models to be trained and evaluated. The configuration file(s) serve as central control documents that define operational parameters for automated retrieval and processing of multiple data sources and for generating and using machine learning models. The configuration file(s) may be stored by the configuration management module in a version-controlled repository implemented within data memory 770, enabling tracking of changes and maintenance of configuration history.

At 604A, the system may prepare data based on the configuration file(s) generated at 602A. This operation may be performed by data preparation component 220. Data pipeline element 222 may retrieve data from data lake 221 according to specifications in the configuration file(s), where data lake 221 stores structured, semi-structured, and/or unstructured data from various sources such as HR systems and payroll databases. Data pipeline element 222 may construct queries to extract specific data attributes (e.g., salary information, home and office addresses, employee type and role) based on configuration parameters. For each employee type defined in the configuration file(s), system 200 may create separate data chunks that are filtered and validated for relevance to that particular type, with processing potentially occurring in parallel through decision box 217. Data integration and preparation element 223 may then merge data from multiple sources using, e.g., common identifiers (e.g., employee IDs), detect missing data, and/or implement imputation strategies based on configuration rules. Feature engineering element 224 may transform the integrated data according to configurations defined in the configuration file(s) by feature type and toggle element 213, categorizing data into interval, ordinal, and categorical types. In some embodiments, feature engineering element 224 creates one or more new derived features based on contextual rules. In some embodiments, feature engineering element 224 may perform club labeling based on criteria in the configuration file(s) from club label element 214, organizing data points into groups to manage dimensionality and improve model generalization. Finally, feature vectorization element 225 may convert all processed data into numerical vectors suitable for machine learning algorithms, incorporating ordinal rankings from ordinal rank element 215 to preserve hierarchical relationships. The vectorized data may then be passed to model processing component 230 through decision box 218 for model training, testing, and/or validation.

At 606A, the system may generate one or more machine learning models using the prepared data. This operation may be performed by model processing component 230. Machine learning element 231 may train multiple models as defined in model list element 216 (e.g., logistic regression models, decision tree models, random forest models, and XGBoost models), with each model having specified parameters and hyperparameters. The system may employ RandomCV method for parameter optimization, enabling parallel processing for enhanced computational efficiency. The training may occur in parallel to efficiently learn patterns across the vectorized data. Result publication element 232 may publish each model's performance metrics. Result validation element 233 may evaluate these metrics by comparing model performance on both training and testing datasets to identify potential overfitting or underfitting issues. Models meeting performance criteria (e.g., logistic regression models achieving 85% accuracy, 84% precision, and 85% recall) may be listed in top performing model list element 234. For these top-performing models, machine learning element 231 may convert the models (including their trained parameters, weights, and structure) into a serialized format, and the configuration management module may store them using various formats suitable for machine learning models, such as binary serialization formats, standardized formats for interoperability, or framework-specific formats, enabling efficient retrieval and reconstruction for subsequent real-time predictions.

During model development, ensemble element 235 may implement techniques including: bagging-based techniques with bootstrap aggregation of models trained on different data subsets; boosting-based approaches with sequential model development where subsequent models focus on previous models' errors; and training meta-models for stacking approaches. Ensemble element 235 may adaptively adjust its methods based on historical performance, computational resources, and accuracy requirements. In parallel, SHAP element 236 and SHAP composer 237 may analyze how individual features influence model predictions to guide feature selection and model refinement. The insights derived from this analysis may be used to iteratively refine aspects of the machine learning pipeline, such as adjusting feature configurations in the configuration file(s), modifying data preparation procedures, optimizing model development parameters, or a combination thereof.

At 608A, the system may provide model output through model output component 240. App 241 may present model development results in an interactive GUI format, displaying performance metrics (e.g., model accuracy, precision, recall) and allowing users to explore and analyze model behavior through dashboards, charts, or visual analytics. Users may explore results through various parameters such as department, job role, or location. Monitoring element 242 may provide ongoing assessment of model performance during training, tracking accuracy, stability, and other metrics. Users may provide feedback through app 241 or monitoring element 242 for model refinement and optimization.

FIG. 6B illustrates a process 600B for applying trained machine learning models for employee attrition prediction, according to some embodiments. The operations of process 600B may be performed by components of system 200, as illustrated in FIG. 2, with additional operations possible as described in connection with various components of system 200.

At 602B, the system may obtain configuration file(s) for guiding data preparation and model application. The configuration management module of system 200 may retrieve relevant configuration file(s) from the version-controlled repository maintained in data memory 770 of storage memory 908. These configuration file(s) may be, e.g., the same or similar configuration file(s) used in model development, or a portion thereof. Through a configuration interface, a user may specify one or more applicable parameters or select specific configuration file(s) suitable for the current prediction task.

At 604B, the system may prepare data based on the obtained configuration file(s). This operation may be performed by data preparation component 220 following the workflow described with respect to 604A. Data pipeline element 222 may retrieve data from data lake 221 according to specifications in the configuration file(s), where the data pertains to one or multiple employees for whom attrition risk is to be assessed. Data pipeline element 222 may construct queries to extract specific data attributes based on configuration parameters. For each employee type, system 200 may create separate data chunks that are filtered and validated for relevance, with processing potentially occurring in parallel through decision box 217. Data integration and preparation element 223 may then merge data from multiple sources, detect missing data, and implement imputation strategies based on configuration rules. Feature engineering element 224 may transform the integrated data according to configurations, including creating derived features and performing club labeling. Finally, feature vectorization element 225 may convert all processed data into numerical vectors suitable for model application, incorporating ordinal rankings to preserve hierarchical relationships.

At 606B, the system may generate predictions using the prepared data by applying one or more trained models. This operation may be performed by model processing component 230. For a specific prediction task, the configuration management module may first identify and retrieve relevant trained models based on criteria specified in the configuration file(s). These models may have been previously stored during model development in various formats suitable for machine learning models. The system may prioritize models with higher accuracy metrics (e.g., the logistic regression models achieving 85% accuracy, 84% precision, and 85% recall). Additionally, model selection may consider computational efficiency requirements, prediction time constraints, and specific feature availability in the current data. Machine learning element 231 may then load the selected model files and perform deserialization to reconstruct the complete model objects, including their architecture, trained parameters, and weights, back into functional models that maintain their original characteristics and capabilities. These reconstructed models may then be applied to the prepared data to generate predictions.

Result publication element 232 may publish prediction results and associated confidence metrics. In some embodiments, result validation element 233 may evaluate prediction confidence metrics and validate that predictions fall within expected ranges based on historical patterns. The predictions may be output directly, or in some embodiments, may be processed by ensemble element 235 and/or analyzed by SHAP element 236 and SHAP composer 237, with these operations optionally performed in parallel to improve efficiency. During model application, ensemble element 235 may combine predictions from multiple trained models using various techniques. These techniques may include weighted averaging, where model-specific weights may be determined based on various factors such as validation performance metrics (e.g., accuracy, AUC-ROC, or F1-score), cross-validation stability scores, model confidence scores, or weights optimized through computational methods such as grid search or Bayesian optimization. For classification tasks (e.g., tasks involving assigning one or multiple employees to one of multiple predefined groups, such as high risk, medium risk, and/or low risk groups), ensemble element 235 may implement voting mechanisms. These mechanisms may include hard voting (where each model casts a binary vote and the majority prediction is selected), soft voting (where probability predictions are averaged and thresholded), or weighted voting (where votes are weighted by model confidence or historical performance). Additionally, ensemble element 235 may apply meta-models trained during the model development phase to combine predictions in a stacking approach. SHAP element 236 and SHAP composer 237 may analyze feature influences on the predictions, providing interpretability by revealing, for example, the relative importance of factors such as salary information or department in determining an employee's predicted likelihood of leaving. The SHAP analysis results may be aggregated into human-readable explanations to accompany the predictions.

At 608B, the system may output predictions through model output component 240. App 241 may present predictions from individual models or ensemble results in an interactive GUI format, allowing users to explore and analyze predictions through dashboards, charts, or visual analytics. Users may input specific parameters or filter results based on criteria such as department, job role, or location, with the interface supporting real-time updates of predictive outputs based on modified inputs. The system may be configured to generate alerts when an employee's predicted attrition risk exceeds a threshold, which may be user-defined or automatically determined through analysis of historical prediction-outcome pairs. These alerts may be displayed within the GUI with contextual details and may include SHAP-based explanations of contributing factors to facilitate proactive retention measures. Monitoring element 242 may provide ongoing assessment of prediction accuracy and reliability. Upon detecting anomalies or unexpected prediction patterns, monitoring element 242 may generate alerts. Users may provide feedback through app 241 or monitoring element 242 regarding prediction accuracy and relevance.

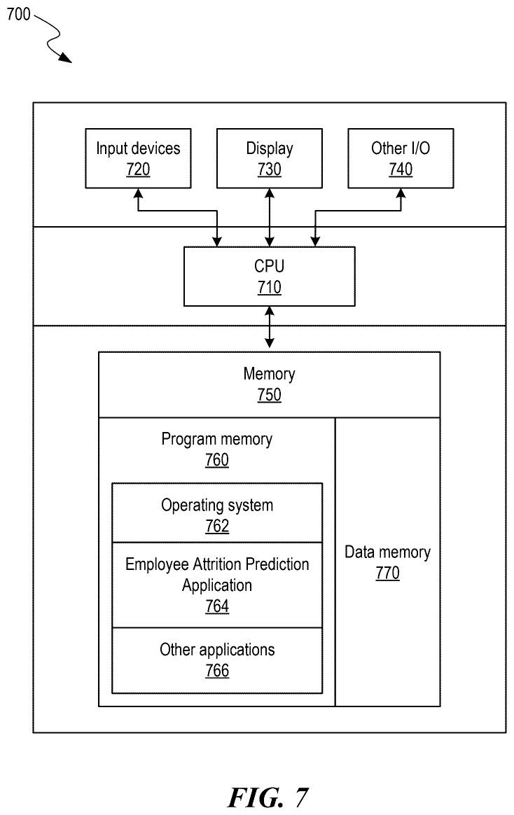

Several implementations are discussed below in more detail in reference to the figures. FIG. 7 is a block diagram illustrating an overview of devices on which some implementations of the disclosed technology can operate. The devices can comprise hardware components of a device 700. Device 700 may be used to implement one or more components of system 200 (illustrated in FIG. 2) and/or execute operations of process 600A (model development process) or 600B (model application process) illustrated in FIGS. 6A and 6B respectively. Device 700 may provide the hardware foundation for performing processes for employee attrition prediction, and comprises memory (e.g., memory 750) storing computer-readable instructions; one or more processors (e.g., CPU (processor) 710) that, when executing the computer-readable instructions, are configured to perform the processes described. For example, device 700 may be used to execute or implement various components of system 200, including but not limited to configuration component 210, data preparation component 220, model processing component 230, and model output component 240. These components may correspond to operations of either process 600A or 600B for predicting employee attrition. For process 600A, device 700 may execute memory-stored computer-readable instructions to perform: generating configuration file(s) (602A), automatically preparing data (604A), automatically generating and evaluating machine learning models (606A), and providing output of model training and evaluation results (608A). For process 600B, device 700 may execute instructions to perform: obtaining configuration file(s) (602B), automatically preparing current data (604B), automatically generating predictions using trained models (606B), and providing output based on generated predictions (608B).

The technology disclosed herein demonstrates robust capabilities in handling diverse, large-scale, and dynamic data sources for employee attrition prediction. By integrating multiple data sources into a unified dataset, the system can process a comprehensive range of information including demographics, compensation details, leave patterns, engagement survey responses, performance metrics, benefits information, career movements (promotions and demotions), and location-based data. The system's ability to handle high-volume data is evidenced by its successful processing of over 30,000 instances with more than 40 attributes per instance in exemplary uses. Furthermore, the technology is designed to accommodate the velocity of real-world data generation, where employee information changes rapidly on a daily basis. This sophisticated data integration and processing capability contributes to the system's high prediction accuracy, as demonstrated by performance metrics such as 85% accuracy in logistic regression models. The system's ability to unify and process such diverse, voluminous, and rapidly changing data makes it particularly valuable for large organizations with complex workforce dynamics.

Device 700 may include one or more input devices 720 that provide input to the CPU (processor) 710, notifying it of actions. The actions are typically mediated by a hardware controller that interprets the signals received from the input device and communicates the information to the CPU 710 using a communication protocol. Input devices 720 include, for example, a mouse, a keyboard, a touchscreen, an infrared sensor, a touchpad, a wearable input device, a camera-or image-based input device, a microphone, or other user input devices.

Through input devices 720, users may interact with various components of system 200. During model development (process 600A), users may specify configuration parameters through a configuration interface, define model parameters, or provide feedback for model refinement. During model application (process 600B), users may select configuration file(s), specify parameters for prediction tasks, filter prediction results, or provide feedback on predictions. These interactions may occur through app 241 of model output component 240, allowing users to explore insights in real time.

CPU 710 may include a single processing unit or multiple processing units, either within a single device or distributed across multiple devices. CPU 710 may execute the computer-readable instructions stored in memory 750 to carry out processes 600A and 600B. For process 600A, CPU 710 may execute instructions to generate configuration file(s) (602A), automatically prepare data (604A), automatically generate and evaluate models (606A), and provide model development output (608A). For process 600B, CPU 710 may execute instructions to obtain configuration file(s) (602B), automatically prepare current data (604B), automatically generate predictions (606B), and provide prediction output (608B).

Display 730 can be utilized to present visual feedback through GUI(s) described above in connection with FIGS. 3-5. For process 600A, this may include visualizations of model performance metrics, feature importance analyses, and training results. For process 600B, this may include visualizations of attrition predictions, risk alerts, and prediction explanations. App 241 may enable user interaction through graphical elements like charts and filters. The display may be integrated with an input device (e.g., touchscreen) or function separately.

Device 700 may include a communication device (within other I/O devices 740) for connecting to network nodes, enabling data pipeline element 222 to access distributed data sources (data lake 221) across a network. The communication device enables parallel processing operations (e.g., parallel data preparation in 604A/B through decision box 217, parallel model development in 606A, parallel ensemble and SHAP processing in 606B) and allows real-time monitoring of model performance and predictions.

Memory 750 may include volatile and non-volatile storage hardware, such as RAM, ROM, flash memory, and hard drives. Memory 750 may store program memory 760, which includes operating system 762, an employee attrition prediction application 764, and other application programs 766. Application 764 implements components of system 200 to execute processes 600A and 600B. During model development, application 764 may instantiate machine learning element 231 for developing models. During model application, it may apply trained models to generate predictions.

Data memory 770 stores data needed for executing both processes. For process 600A, this includes training/testing data, configurations, feature definitions, and model parameters. For process 600B, this includes trained models, current employee data, and prediction results. Data memory 770 may be implemented within storage memory 908 and may correspond to configuration storage within system 200, serving as the version-controlled repository for configuration file(s) managed by the configuration management module. For example, the configuration management module may store serialized models and configuration file(s) in a version-controlled repository implemented within data memory 770 of device 700. During model application, the module may retrieve these files from the repository, which is maintained in persistent storage memory 908.

Device 700 may operate in various computing environments and configurations supporting system 200 and processes 600A/B. These environments may include personal computers, server computers, laptops, mobile devices, wearables, gaming consoles, or distributed computing setups suitable for predictive analytics and machine learning tasks. For example, system 200 may be implemented across a cloud-based distributed computing environment where components like model processing component 230 and data preparation component 220 are executed on separate servers, with device 700 orchestrating their interaction.

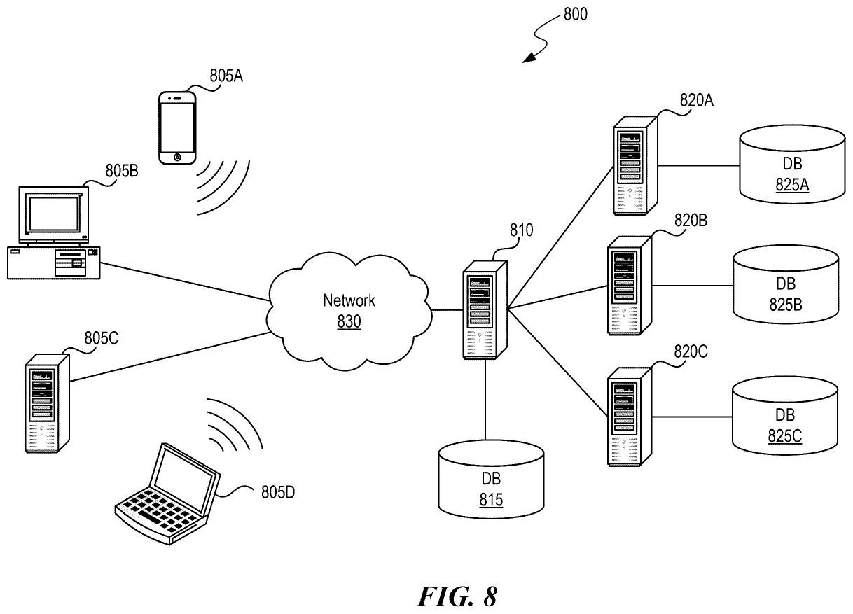

FIG. 8 is a block diagram illustrating an overview of an environment 800 in which some implementations of the disclosed technology can operate, according to some embodiments. Environment 800 can include one or more client computing devices 805A-805D, examples of which can include device 700. This environment may include components that may implement or interact with components of system 200 (shown in FIG. 2) and execute the steps of process 600A or 600B (shown in FIG. 6A or 6B). For example, during model development (process 600A), client computing devices and server devices in environment 800 may handle user interactions for generating configuration file(s), displaying model development results, and providing feedback. As another example, during model application (process 600B), client computing devices and server devices in environment 800 may handle user interactions for obtaining configurations, displaying predictions, and providing feedback. The interaction may occur through configuration component 210 and app 241 of model output component 240. Client computing devices 805 can operate in a networked environment using logical connections through network 830 to one or more remote computers, such as a server computing device 810. The client computing devices may handle user interaction for defining configurations (e.g., configuration component 210) and display outputs (e.g., through app 241 in model output component 240).

In some embodiments, server computing device 810 may act as an edge server, which receives client requests and coordinates the fulfillment of those requests through other servers, such as servers 820A-820C. Both server computing devices 810 and 820 may include computing systems similar to device 700 and may implement specific components of system 200 or execute operations of process 600A or 600B. For process 600A, server 810 may orchestrate data preparation (604A) through data preparation component 220, while servers 820A-820C may handle model development (606A) through model processing component 230, including parallel training, testing, and validation operations. For process 600B, server 810 may coordinate data preparation (604B), while servers 820A-820C may handle prediction generation (606B), including parallel ensemble and SHAP processing. Though represented as single logical units, these computing devices may be part of a distributed computing environment that spans across geographically disparate physical locations or function as part of a server cluster to enhance scalability and parallel processing.

Client computing devices 805, server computing device 810, and server computing devices 820 may function as servers or clients in various interactions, including managing configurations, data retrieval, and predictive model generation. Server 810 may be connected to a database 815, which can store configurations, data, and model parameters for system 200. Similarly, servers 820A-820C may be connected to corresponding databases 825A-825C, which can warehouse data such as feature types, cohort labels, model development outcomes, training/testing data and trained models, and/or current employee data and predictions for process 600A or 600B. These databases can be distributed or centralized, enabling efficient data retrieval for different operations of process 600A or 600B, such as data retrieval, validation, and imputation in operation 604A or 604B according to specifications in the configuration file(s).

Network 830 can be a local area network (LAN) or a wide area network (WAN), but can also be other wired or wireless networks. Network 830 may be the Internet or some other public or private network. Client computing devices 805 can be connected to network 830 through a network interface, such as by wired or wireless communication. While the connections between server 810 and servers 820 are shown as separate connections, these connections can be any kind of local, wide area, wired, or wireless network, including network 830 or a separate public or private network.

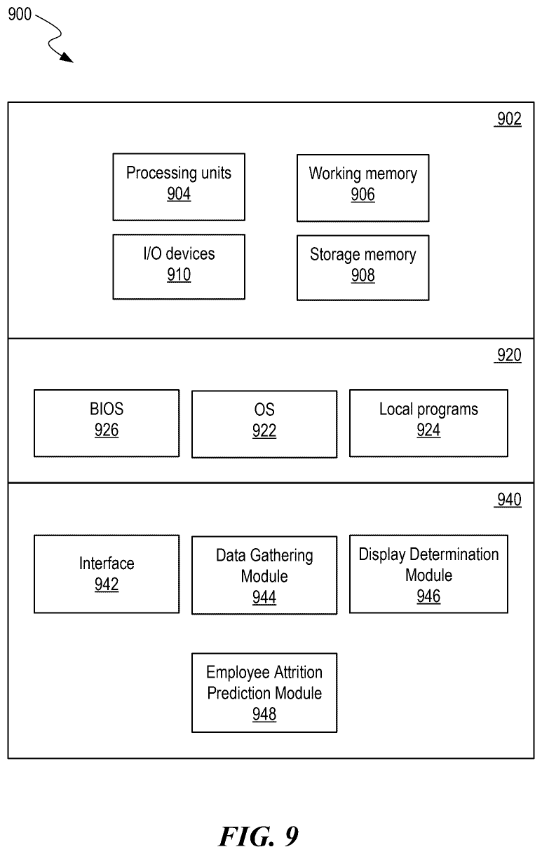

FIG. 9 is a block diagram illustrating components 900 which, in some implementations, can be used in a system employing the disclosed technology (e.g., parts of system 200 and/or execution of process 600A or 600B). The components 900 include hardware 902, general software 920, and specialized components 940. As discussed above, a system implementing the disclosed technology can use various hardware, including processing units 904 (e.g., CPUs, GPUs, APUs, etc.), working memory 906, storage memory 908, and input and output devices 910. Components 900 can be implemented in a client computing device such as client computing devices 805 or on a server computing device, such as server computing device 810 or 820, which can support the execution of components such as, e.g., configuration component 210, data preparation component 220, model processing component 230, and model output component 240.

General software 920 can include various applications, including an operating system 922, local programs 924, and a basic input output system (BIOS) 926. Specialized components 940 can be subcomponents of a general software application 920, such as local programs 924. Specialized components 940 can include a Data Gathering module 944, Display Determination module 946, Employee Attrition Prediction module 948, and components that can be used for transferring data and controlling the specialized components, such as interface 942. In some implementations, components 900 can be in a computing system that is distributed across multiple computing devices or can be an interface to a server-based application executing one or more of specialized components 940. For instance, Data Gathering module 944 may implement data preparation operations (604A, 604B), Employee Attrition Prediction module 948 may implement model development operations (606A) and prediction generation operations (606B), and Display Determination module 946 may implement output operations (608A, 608B) through model output component 240.

Those skilled in the art will appreciate that the components illustrated in FIGS. 7-9 described above, and in each of the flow diagrams discussed above, may be altered in a variety of ways. For example, the order of the logic may be rearranged, sub steps may be performed in parallel, illustrated logic may be omitted, other logic may be included, etc. In some implementations, one or more of the components described above can execute one or more of the processes described below.

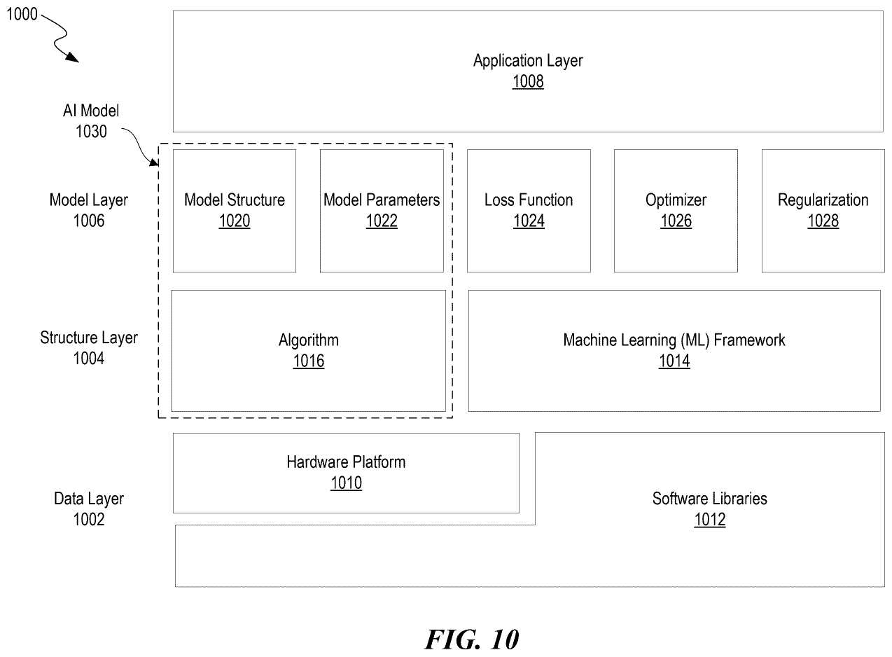

FIG. 10 is an AI architecture, according to some embodiments. As shown, the AI system 1000 can include a set of layers, which conceptually organize elements within an example network topology for the AI system's architecture to implement a particular AI model 1030. Generally, an AI model 1030 is a computer-executable program implemented by the AI system 1000 that analyses data to make predictions. Information can pass through each layer of the AI system 1000 to generate outputs for the AI model 1030. The layers can include a data layer 1002, a structure layer 1004, a model layer 1006, and an application layer 1008. The algorithm 1016 of the structure layer 1004 and the model structure 1020 and model parameters 1022 of the model layer 1006 together form the example AI model 1030. The optimizer 1026, loss function engine 1024, and regularization engine 1028 work to refine and optimize the AI model 1030, and the data layer 1002 provides resources and support for application of the AI model 1030 by the application layer 1008. These components may correspond to components of device 700. In the context of employee attrition prediction, these components may be used to execute both model development operations in process 600A and model application operations in process 600B through model processing component 230.

The data layer 1002 acts as the foundation of the AI system 1000 by preparing data for the AI model 1030. As shown, the data layer 1002 can include two sub-layers: a hardware platform 1010 and one or more software libraries 1012. The hardware platform 1010 can be designed to perform operations for the AI model 1030 and include computing resources for storage, memory, logic, and networking, such as the resources described in relation to FIG. 2. The hardware platform 1010 can process amounts of data using one or more servers. The servers can perform backend operations such as matrix calculations, parallel calculations, machine learning (ML) training, and the like. Examples of servers used by the hardware platform 1010 include central processing units (CPUs) and graphics processing units (GPUs). CPUs are electronic circuitry designed to execute instructions for computer programs, such as arithmetic, logic, controlling, and input/output (I/O) operations, and can be implemented on integrated circuit (IC) microprocessors. GPUs are electric circuits that were originally designed for graphics manipulation and output but may be used for AI applications due to their vast computing and memory resources. GPUs use a parallel structure that generally makes their processing more efficient than that of CPUs. In some instances, the hardware platform 1010 can include Infrastructure as a Service (IaaS) resources, which are computing resources, (e.g., servers, memory, etc.) offered by a cloud services provider. The hardware platform 1010 can also include computer memory for storing data about the AI model 1030, application of the AI model 1030, and training data for the AI model 1030. The computer memory can be a form of random-access memory (RAM), such as dynamic RAM, static RAM, and non-volatile RAM.

The software libraries 1012 can be thought of as suites of data and programming code, including executables, used to control the computing resources of the hardware platform 1010. The programming code can include low-level primitives (e.g., fundamental language elements) that form the foundation of one or more low-level programming languages, such that servers of the hardware platform 1010 can use the low-level primitives to carry out specific operations. The low-level programming languages do not require much, if any, abstraction from a computing resource's instruction set architecture, allowing them to run quickly with a small memory footprint. Examples of software libraries 1012 that can be included in the AI system 1000 include Intel Math Kernel Library, Nvidia cuDNN, Eigen, and Open BLAS.

The structure layer 1004 can include an ML framework 1014 and an algorithm 1016. The ML framework 1014 can be thought of as an interface, library, or tool that allows users to build and deploy the AI model 1030. The ML framework 1014 can include an open-source library, an application programming interface (API), a gradient-boosting library, an ensemble method, and/or a deep learning toolkit that work with the layers of the AI system facilitate development of the AI model 1030. For example, the ML framework 1014 can distribute processes for application or training of the AI model 1030 across multiple resources in the hardware platform 1010. The ML framework 1014 can also include a set of pre-built components that have the functionality to implement and train the AI model 1030 and allow users to use pre-built functions and classes to construct and train the AI model 1030. Thus, the ML framework 1014 can be used to facilitate data engineering, development, hyperparameter tuning, testing, and training for the AI model 1030. Examples of ML framework 1014 that can be used in the AI system 1000 include TensorFlow, PyTorch, Scikit-Learn, Keras, Cafffe, LightGBM, Random Forest, and Amazon Web Services.

The algorithm 1016 can be an organized set of computer-executable operations used to generate output data from a set of input data and can be described using pseudocode. The algorithm 1016 can include complex code that allows the computing resources to learn from new input data and create new/modified outputs based on what was learned. In some implementations, the algorithm 1016 can build the AI model 1030 through being trained while running computing resources of the hardware platform 1010. This training allows the algorithm 1016 to make predictions or decisions without being explicitly programmed to do so. Once trained, the algorithm 1016 can run at the computing resources as part of the AI model 1030 to make predictions or decisions, improve computing resource performance, or perform tasks. The algorithm 1016 can be trained using supervised learning, unsupervised learning, semi-supervised learning, and/or reinforcement learning.

Using supervised learning, the algorithm 1016 can be trained to learn patterns (e.g., map input data to output data) based on labeled training data. The training data may be labeled by an external user or operator. For instance, a user may collect a set of training data, such as by capturing data from sensors, images from a camera, outputs from a model, and the like. In an example implementation related to employee attrition prediction, training data can include data specified in configuration file(s) through configuration component 210, including data source information, employee type classifications, feature categorizations, club labeling criteria, ordinal ranking definitions, and model specifications as already described. The user may label the training data based on one or more classes and trains the AI model 1030 by inputting the training data to the algorithm 1016. The algorithm determines how to label the new data based on the labeled training data. The user can facilitate collection, labeling, and/or input via the ML framework 1014. In some instances, the user may convert the training data to a set of feature vectors for input to the algorithm 1016. Once trained, the user can test the algorithm 1016 on new data to determine if the algorithm 1016 is predicting accurate labels for the new data. For example, the user can use cross-validation methods to test the accuracy of the algorithm 1016 and retrain the algorithm 1016 on new training data if the results of the cross-validation are below an accuracy threshold.

Supervised learning can involve classification and/or regression. Classification techniques involve teaching the algorithm 1016 to identify a category of new observations based on training data and are used when input data for the algorithm 1016 is discrete. Said differently, when learning through classification techniques, the algorithm 1016 receives training data labeled with categories (e.g., classes) and determines how features observed in the training data (such as from feature engineering element 224) relate to the categories (such as in feature vectorization 225). Once trained, the algorithm 1016 can categorize new data by analyzing the new data for features that map to the categories. Examples of classification techniques include boosting, decision tree learning, genetic programming, learning vector quantization, k-nearest neighbor (k-NN) algorithm, and statistical classification.

Regression techniques involve estimating relationships between independent and dependent variables and are used when input data to the algorithm 1016 is continuous. Regression techniques can be used to train the algorithm 1016 to predict or forecast relationships between variables. To train the algorithm 1016 using regression techniques, a user can select a regression method for estimating the parameters of the model. The user collects and labels training data that is input to the algorithm 1016 such that the algorithm 1016 is trained to understand the relationship between data features and the dependent variable(s). Once trained, the algorithm 1016 can predict missing historic data or future outcomes based on input data. Examples of regression methods include linear regression, multiple linear regression, logistic regression, regression tree analysis, least squares method, and gradient descent. In an example implementation, regression techniques can be used, for example, to estimate and fill-in missing data for machine-learning based pre-processing operations.

Under unsupervised learning, the algorithm 1016 learns patterns from unlabeled training data. In particular, the algorithm 1016 is trained to learn hidden patterns and insights of input data, which can be used for data exploration or for generating new data. Here, the algorithm 1016 does not have a predefined output, unlike the labels output when the algorithm 1016 is trained using supervised learning. Said another way, unsupervised learning is used to train the algorithm 1016 to find an underlying structure of a set of data, group the data according to similarities, and represent that set of data in a compressed format. The attrition prediction system shown in FIG. 2 can use unsupervised learning techniques during model development through model processing component 230 to identify patterns relevant to employee attrition prediction.

A few techniques can be used in supervised learning: clustering, anomaly detection, and techniques for learning latent variable models. Clustering techniques involve grouping data into different clusters that include similar data, such that other clusters contain dissimilar data. For example, during clustering, data with possible similarities remain in a group that has less or no similarities to another group. Examples of clustering techniques density-based methods, hierarchical based methods, partitioning methods, and grid-based methods. In one example, the algorithm 1016 may be trained to be a k-means clustering algorithm, which partitions n observations in k clusters such that each observation belongs to the cluster with the nearest mean serving as a prototype of the cluster. Anomaly detection techniques are used to detect previously unseen rare objects or events represented in data without prior knowledge of these objects or events. Anomalies can include data that occur rarely in a set, a deviation from other observations, outliers that are inconsistent with the rest of the data, patterns that do not conform to well-defined normal behavior, and the like. When using anomaly detection techniques, the algorithm 1016 may be trained to be an Isolation Forest, local outlier factor (LOF) algorithm, or K-nearest neighbor (k-NN) algorithm. Latent variable techniques involve relating observable variables to a set of latent variables. These techniques assume that the observable variables are the result of an individual's position on the latent variables and that the observable variables have nothing in common after controlling for the latent variables. Examples of latent variable techniques that may be used by the algorithm 1016 include factor analysis, item response theory, latent profile analysis, and latent class analysis.

The model layer 1006 implements the AI model 1030 using data from the data layer and the algorithm 1016 and ML framework 1014 from the structure layer 1004, thus enabling decision-making capabilities of the AI system 1000. The model layer 1006 includes a model structure 1020, model parameters 1022, a loss function engine 1024, an optimizer 1026, and a regularization engine 1028.

The model structure 1020 describes the architecture of the AI model 1030 of the AI system 1000. The model structure 1020 defines the complexity of the pattern/relationship that the AI model 1030 expresses. Examples of structures that can be used as the model structure 1020 include decision trees, support vector machines, regression analyses, Bayesian networks, Gaussian processes, genetic algorithms, and artificial neural networks (or, simply, neural networks). The model structure 1020 can include a number of structure layers, a number of nodes (or neurons) at each structure layer, and activation functions of each node. Each node's activation function defines how to node converts data received to data output. The structure layers may include an input layer of nodes that receive input data, an output layer of nodes that produce output data. The model structure 1020 may include one or more hidden layers of nodes between the input and output layers. The model structure 1020 can be an Artificial Neural Network (or, simply, neural network) that connects the nodes in the structured layers such that the nodes are interconnected. Examples of neural networks include Feedforward Neural Networks, convolutional neural networks (CNNs), Recurrent Neural Networks (RNNs), Autoencoder, and Generative Adversarial Networks (GANs).

The model parameters 1022 represent the relationships learned during training and can be used to make predictions and decisions based on input data. The model parameters 1022 can weight and bias the nodes and connections of the model structure 1020. For instance, when the model structure 1020 is a neural network, the model parameters 1022 can weight and bias the nodes in each layer of the neural networks, such that the weights determine the strength of the nodes and the biases determine the thresholds for the activation functions of each node. The model parameters 1022, in conjunction with the activation functions of the nodes, determine how input data is transformed into desired outputs. The model parameters 1022 can be determined and/or altered during training of the algorithm 1016.

The loss function engine 1024 can determine a loss function, which is a metric used to evaluate the AI model's 330 performance during training. For instance, the loss function engine 1024 can measure the difference between a predicted output of the AI model 1030 and the actual output of the AI model 1030 and is used to guide optimization of the AI model 1030 during training to minimize the loss function. The loss function may be presented via the ML framework 1014, such that a user can determine whether to retrain or otherwise alter the algorithm 1016 if the loss function is over a threshold. In some instances, the algorithm 1016 can be retrained automatically if the loss function is over the threshold. Examples of loss functions include a binary-cross entropy function, hinge loss function, regression loss function (e.g., mean square error, quadratic loss, etc.), mean absolute error function, smooth mean absolute error function, log-cosh loss function, and quantile loss function.

The optimizer 1026 adjusts the model parameters 1022 to minimize the loss function during training of the algorithm 1016. In other words, the optimizer 1026 uses the loss function generated by the loss function engine 1024 as a guide to determine what model parameters lead to the most accurate AI model 1030. Examples of optimizers include Gradient Descent (GD), Adaptive Gradient Algorithm (AdaGrad), Adaptive Moment Estimation (Adam), Root Mean Square Propagation (RMSprop), Radial Base Function (RBF) and Limited-memory BFGS (L-BFGS). The type of optimizer 1026 used may be determined based on the type of model structure 1020 and the size of data and the computing resources available in the data layer 1002.

The regularization engine 1028 executes regularization operations. Regularization is a technique that prevents over-and under-fitting of the AI model 1030. Overfitting occurs when the algorithm 1016 is overly complex and too adapted to the training data, which can result in poor performance of the AI model 1030. Underfitting occurs when the algorithm 1016 is unable to recognize even basic patterns from the training data such that it cannot perform well on training data or on validation data. The regularization engine 1028 can apply one or more regularization techniques to fit the algorithm 1016 to the training data properly, which helps constraint the resulting AI model 1030 and improves its ability for generalized application. Examples of regularization techniques include lasso (L1) regularization, ridge (L2) regularization, and elastic (L1 and L2 regularization).

The application layer 1008 describes how the AI system 1000 is used to solve problem or perform tasks. In an example implementation in the context of employee attrition prediction, the application layer 1008 implements the operations of processes 600A and 600B through components of system 200, including data preparation component 220 and model processing component 230.

While the descriptions herein mainly focus on employee attrition prediction, the technology underlying the described systems and methods can be broadly applied across various domains, utilizing different types of data, features, and configurations to achieve predictive insights. Below are examples of how the disclosed technology may be adapted to other applications, such as loan default prediction and patient disease prediction. These examples may utilize the components of system 200 (FIG. 2) following either process 600A for model development or process 600B for model application. While the core architecture and processing operations remain substantially consistent, the specific data sources, feature types, and models can be adapted to each application's unique needs.

Loan default prediction aims to forecast the likelihood of a borrower defaulting on a loan, enabling informed lending decisions and risk management. Components of system 200 may be adapted as follows:

Configuration component 210 may generate configuration file(s) specifying data sources such as credit bureaus, loan applications, and banking transactions. The system may define entity types (e.g., mortgage loans, personal loans) analogous to worker types in the attrition prediction case. Feature categorizations may include credit scores, debt ratios, and payment history. The component may also define club labeling criteria for organizing related features, establish ordinal rankings for categorical data, and maintain model specifications.

Data preparation component 220 may retrieve and validate financial data according to the configuration file(s). The component may perform data integration across multiple sources and implement imputation strategies for missing data. Feature engineering may create derived features such as loan-to-value ratios and income growth rates. Finally, the component may convert all processed data into vectors suitable for model processing.

Model processing component 230 may serve different functions depending on the process. During model development (process 600A), it may train and evaluate various models such as logistic regression and decision trees, select top-performing models based on metrics, implement ensemble techniques, and analyze feature importance. During model application (process 600B), it may generate default risk predictions using trained models, apply ensemble methods to combine predictions, and provide prediction explanations through SHAP analysis.

Model output component 240 may present risk scores and predictions through interactive dashboards. The component may generate alerts for high-risk cases and provide filtering capabilities for detailed analysis. Users may interact with the interface to explore predictions and understand contributing factors to default risk.

Patient disease prediction can leverage medical data to identify the likelihood of an individual developing a specific disease, enabling proactive healthcare interventions and personalized treatment plans. Components of system 200 may be adapted as follows:

Configuration component 210 may generate configuration file(s) specifying various medical data sources such as electronic health records (EHRs), genetic profiles, laboratory test results, and wearable device data. The system may define entity types based on patient characteristics (e.g., age groups, risk categories, diagnostic groups) analogous to worker types in the attrition prediction case. Feature categorizations may include physiological measurements, lifestyle data, and historical clinical information. The component may define club labeling criteria for organizing related medical features (e.g., grouping related symptoms or test results), establish ordinal rankings for categorical medical data, and maintain model specifications suitable for healthcare applications.

Data preparation component 220 may retrieve and validate medical data according to the configuration file(s), ensuring compliance with privacy requirements and medical data standards. The component may perform data integration across multiple medical sources and implement imputation strategies based on medical norms for missing data. Feature engineering may create derived features such as BMI trends, vital sign patterns, and risk factor combinations. Finally, the component may convert all processed medical data into vectors suitable for model processing.

Model processing component 230 may serve different functions depending on the process. During model development (process 600A), it may train and evaluate various models such as support vector machines and recurrent neural networks, particularly suited for time-series medical data. The component may select top-performing models based on healthcare-specific metrics (e.g., sensitivity, specificity), implement ensemble techniques, and analyze feature importance for medical factors. During model application (process 600B), it may generate disease risk predictions using trained models, apply ensemble methods to combine predictions, and provide prediction explanations through SHAP analysis to identify key contributing medical factors.

Model output component 240 may present disease risk predictions through interactive medical dashboards. The component may generate alerts for high-risk patients and provide filtering capabilities for analyzing predictions across different patient populations. Healthcare providers may interact with the interface to explore predictions and understand contributing factors to disease risk, enabling informed clinical decision-making.

Beyond employee attrition, loan default, and patient disease prediction, the technology can be adapted to various other domains while maintaining the same systematic approach through processes 600A and 600B. Additional examples are provided below:

Customer churn prediction aims to forecast the likelihood of customers discontinuing their relationship with a business. Configuration component 210 may generate configuration file(s) specifying data sources such as transaction records, service usage logs, and customer feedback. Entity types may be defined based on customer segments (e.g., online or local customers) or service tiers. Feature categorizations may include behavioral metrics, transaction patterns, and interaction histories. Data preparation component 220 may process this data according to configurations, while model processing component 230 may develop or apply models to generate churn predictions.

Fraud detection systems can identify suspicious financial transactions. Configuration component 210 may specify data sources including transaction logs, account profiles, and behavioral patterns. Entity types may be defined by transaction categories or account types. Feature categorizations may include transaction characteristics, temporal patterns, and location data. Model processing component 230 may develop models particularly suited for anomaly detection, or apply these models for real-time fraud prediction.

Supply chain demand forecasting can optimize inventory and logistics management. Configuration file(s) may specify data sources including sales records, inventory levels, and market indicators. Entity types may be defined by product categories or market segments. Feature engineering may create derived metrics such as seasonal patterns and demand trends. Models may be developed to predict future demand across different timeframes and regions.

Predictive maintenance applications can anticipate equipment failures in industrial settings. Configuration file(s) may specify data sources including sensor readings, maintenance logs, and operational metrics. Entity types may be defined by equipment categories. Feature engineering may derive indicators from raw sensor data, while model processing component 230 may develop or apply models to predict maintenance needs.

In educational settings, the technology can predict academic performance and/or student retention. Configuration component 210 may specify data sources including academic records, attendance logs, and assessment results. Entity types may be defined by academic programs or grade levels. Data preparation component 220 may process educational data according to configurations, while model processing component 230 may develop or apply models to identify at-risk students and predict academic outcomes.

These examples demonstrate how the system, as shown in FIG. 2, can be applied to various domains, each with different data sources, feature types, and modeling objectives. The flexibility of the system to adapt its configuration, data processing, and model training steps enables it to deliver predictive insights across diverse applications. The modular components of the system ensure that each use case can be efficiently processed and predicted based on its unique requirements and characteristics.

The above description and drawings are illustrative and are not to be construed as limiting. Numerous specific details are described to provide a thorough understanding of the disclosure. However, in some instances, well-known details are not described in order to avoid obscuring the description. Further, various modifications may be made without deviating from the scope of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. It will be appreciated that the same thing can be said in more than one way. Consequently, alternative language and synonyms may be used for any one or more of the terms discussed herein, and any special significance is not to be placed upon whether or not a term is elaborated or discussed herein. Synonyms for some terms are provided. A recital of one or more synonyms does not exclude the use of other synonyms. The use of examples anywhere in this specification, including examples of any term discussed herein, is illustrative only and is not intended to further limit the scope and meaning of the disclosure or of any exemplified term. Likewise, the disclosure is not limited to various embodiments given in this specification. Unless otherwise defined, all technical and scientific terms used herein have the same meaning as commonly understood by one of ordinary skill in the art to which this disclosure pertains. In the case of conflict, the present document, including definitions, will control.

### EXAMPLES

Some embodiments may implement one or more of the following examples, listed in clause-format. The following clauses are supported and further described in the embodiments above and throughout this document.

Example 1. A computer-implemented method comprising:
generating a configuration file by:
   identifying, in the configuration file, one or more data sources;
   defining one or more groups for the one or more data sources; and
   assigning one or more features to each of the one or more groups;
automatically preparing training data based on the configuration file by:
   retrieving data from the one or more data sources identified in the configuration file;
   validating the retrieved data to detect duplicates, null values, and inconsistencies; and
   obtaining the training data by performing data imputation or removal for detected null values based on predefined rules specified in the configuration file;
automatically generating one or more machine learning models based on the training data by:
   training one or more models using the training data according to the configuration file;
   evaluating performance of each trained model based on predefined performance metrics; and
   selecting one or more top-performing models based on the performance evaluation; and
providing output relating to the selected one or more top-performing models.

Example 2. The method of any one or more examples disclosed herein, wherein generating the configuration file further comprises defining an ordinal rank for one or more categorical features regarding data of the one or more data sources, the ordinal rank representing a hierarchical relationship between values of the one or more categorical features.

Example 3. The method of any one or more examples disclosed herein, wherein generating the configuration file further comprises dynamically updating the configuration file based on user input received through a user interface.

Example 4. The method of any one or more examples disclosed herein, wherein preparing the training data further comprises integrating data from multiple data sources by aligning the retrieved data using one or more identifiers.

Example 5. The method of any one or more examples disclosed herein, wherein preparing the training data comprises creating one or more derived features based on a combination of existing features specified in the configuration file, wherein the one or more derived features are added to the training data before training the one or more machine learning models.

Example 6. The method of any one or more examples disclosed herein, wherein the data imputation is based on at least one statistical measure of feature values in the retrieved data.

Example 7. The method of any one or more examples disclosed herein, wherein training the one or more machine learning models comprises using hyperparameter optimization to identify optimal model parameters for at least one of the trained one or more models.

Example 8. The method of any one or more examples disclosed herein, wherein the predefined performance metrics comprises one or more of accuracy, precision, recall, F1 score, or an area under a receiver operating characteristic (ROC) curve.

Example 9. The method of any one or more examples disclosed herein, further comprising performing an ensemble operation by aggregating the predictions generated by the one or more top-performing models to produce a final prediction.

Example 10. The method of any one or more examples disclosed herein, wherein providing the output comprises generating a visualization of the output through a graphical user interface (GUI).

Example 11. The method of any one or more examples disclosed herein, wherein the GUI comprises a filter configured to receive a user-specified parameter for filtering the visualized output or generating (or updating) the configuration file.

Example 12. The method of any one or more examples disclosed herein, further comprising performing model serialization on the selected one or more top-performing models for storage.

Example 13. The method of any one or more examples disclosed herein, further comprising storing the configuration file in a version-controlled repository.

Example 14. The method of claim 1, wherein the automated preparation of the training data at least partially proceeds in parallel for the one or more groups defined in the configuration file.

Example 15. The method of any one or more examples disclosed herein, further comprising automatically updating the configuration file based on the performance of the trained models.

Example 16. The method of any one or more examples disclosed herein, further comprising determining feature importance of each of one or more of the features based on a Shapley value analysis to provide interpretability of model predictions.

Example 17. A computer-implemented method comprising:
obtaining a configuration file;
automatically preparing data based on the configuration file by:
   retrieving data from one or more data sources identified in the configuration file; and
   validating the retrieved data by detecting duplicates, null values, and inconsistencies and performing data imputation or removal for detected null values based on predefined rules specified in the configuration file; and
automatically generating predictions by:
   obtaining one or more machine learning models; and
   applying the one or more models to the prepared data to generate initial predictions; and
providing output based on the generated predictions.

Example 18. The method of any one or more examples disclosed herein, wherein the predictions include a predicted attrition risk for each of one or more employees, the configuration file comprises employee types and features associated with respective employee types.

Example 19. The method of any one or more examples disclosed herein, wherein the predictions relate to a risk of an event, the method further comprising: comparing the predicted risk with a predetermined threshold; and generating an alert for indicating that the predicted risk exceeds the predetermined threshold.

Example 20. The method of any one or more examples disclosed herein, wherein obtaining the configuration file comprises: retrieving the configuration file from a version-controlled repository.

Example 21. The method of any one or more examples disclosed herein, further comprising: receiving, through a user interface, one or more user-specified parameters; and updating the configuration file based on the one or more user-specified parameters.

Example 22. The method of any one or more examples disclosed herein, wherein automatically generating predictions further comprises: evaluating confidence metrics associated with the initial predictions.

Example 23. The method of any one or more examples disclosed herein, wherein automatically generating predictions further comprises: validating the initial predictions by comparing the initial predictions with expected ranges based on historical patterns.

Example 24. The method of any one or more examples disclosed herein, wherein the configuration file comprises data source information, an ordinal rank for one or more categorical features regarding data of the one or more data sources, wherein the ordinal rank represents a hierarchical relationship between values of the one or more categorical features.

Example 25. The method of any one or more examples disclosed herein, wherein preparing the data comprises integrating data from multiple data sources by aligning the retrieved data using one or more identifiers.

Example 26. The method of any one or more examples disclosed herein, wherein the data imputation is based on at least one statistical measure of feature values in the retrieved data.

Example 27. The model of any one or more examples disclosed herein, wherein generating predictions further comprises: loading model files corresponding to the one or more machine learning models; and performing deserialization to reconstruct the one or more machine learning models.

Example 28. The method of any one or more examples disclosed herein, further comprising performing an ensemble operation by aggregating the predictions generated by the one or more machine learning models to produce a final prediction.

Example 29. The method of any one or more examples disclosed herein, wherein providing the output comprises generating a visualization of the predictions through a graphical user interface (GUI).

Example 30. The method of any one or more examples disclosed herein, wherein the GUI comprises a filter configured to receive a user-specified parameter for filtering prediction results or source data.

Example 31. The method of any one or more examples disclosed herein, wherein obtaining the prepared data further comprises performing at least one of operations including: extracting features from the validated data; or generating the prepared date by forming structured datasets through feature vectorization.

Example 32. The method of any one or more examples disclosed herein, wherein: the retrieved data is grouped into a plurality of groups based on group types defined in the configuration file; and the automated preparation of the data at least partially proceeds in parallel for the plurality of groups.

Example 33. The method of any one or more examples disclosed herein, further comprising automatically updating the configuration file based on the performance of the one or more models.

Example 34. The method of any one or more examples disclosed herein, further comprising determining feature importance of each of one or more of the features based on a Shapley value analysis to provide interpretability of model predictions.

Example 35. A system, comprising: memory storing computer-readable instructions; one or more processors that when executing the computer-readable instructions, are configured to perform the method of any one or more examples disclosed herein.

Example 36. One or more non-transitory computer-readable media storing computer-executable instructions that, when executed by one or more processors of a wireless communication device, cause the device to perform the method of any one or more examples disclosed herein.

What is claimed is:

1. A computer-implemented method comprising:
generating a configuration file by:
identifying, in the configuration file, one or more data sources;
defining one or more groups for the one or more data sources; and
assigning one or more features to each of the one or more groups;
automatically preparing training data based on the configuration file by:
retrieving data from the one or more data sources identified in the configuration file;
validating the retrieved data to detect duplicates, null values, and inconsistencies; and
obtaining the training data by performing data imputation or removal for detected null values based on predefined rules specified in the configuration file;
automatically generating one or more machine learning models based on the training data by:
training one or more models using the training data according to the configuration file;
evaluating performance of each trained model based on predefined performance metrics; and
selecting one or more top-performing models based on the performance evaluation; and
providing output relating to the selected one or more top-performing models.

2. The method of claim 1, wherein generating the configuration file further comprises defining an ordinal rank for one or more categorical features regarding data of the one or more data sources, the ordinal rank representing a hierarchical relationship between values of the one or more categorical features.

3. The method of claim 1, wherein generating the configuration file further comprises dynamically updating the configuration file based on user input received through a user interface.

4. The method of claim 1, wherein preparing the training data further comprises integrating data from multiple data sources by aligning the retrieved data using one or more identifiers.

5. The method of claim 1, wherein preparing the training data comprises creating one or more derived features based on a combination of existing features specified in the configuration file, wherein the one or more derived features are added to the training data before training the one or more machine learning models.

6. The method of claim 1, wherein the data imputation is based on at least one statistical measure of feature values in the retrieved data.

7. The method of claim 1, wherein training the one or more machine learning models comprises using hyperparameter optimization to identify optimal model parameters for at least one of the trained one or more models.

8. The method of claim 1, wherein the predefined performance metrics comprises one or more of accuracy, precision, recall, F1 score, or an area under a receiver operating characteristic (ROC) curve.

9. The method of claim 1, further comprising performing an ensemble operation by aggregating the predictions generated by the one or more top-performing models to produce a final prediction.

10. The method of claim 1, further comprising performing model serialization on the selected one or more top-performing models for storage.

11. The method of claim 1, further comprising storing the configuration file in a version-controlled repository.

12. The method of claim 1, wherein the automated preparation of the training data at least partially proceeds in parallel for the one or more groups defined in the configuration file.

13. The method of claim 1, further comprising automatically updating the configuration file based on the performance of the trained models.

14. The method of claim 1, further comprising providing the output comprises generating a visualization of the output through a graphical user interface (GUI).

15. A system, comprising:
memory storing computer-readable instructions;
one or more processors that when executing the computer-readable instructions, are configured to perform operations including:
generating a configuration file by:
identifying, in the configuration file, one or more data sources;
defining one or more groups for the one or more data sources; and
assigning one or more features to each of the one or more groups;
automatically preparing training data based on the configuration file by:
retrieving data from the one or more data sources identified in the configuration file;
validating the retrieved data to detect duplicates, null values, and inconsistencies; and
obtaining the training data by performing data imputation or removal for detected null values based on predefined rules specified in the configuration file;
automatically generating one or more machine learning models based on the training data by:
training one or more models using the training data according to the configuration file;
evaluating performance of each trained model based on predefined performance metrics; and
selecting one or more top-performing models based on the performance evaluation; and
providing output relating to the selected one or more top-performing models.

16. The system of claim 15, wherein the operations further include dynamically updating one or more parameters of the configuration file based on user input received through a graphical user interface.

17. The system of claim 15, wherein the operations further include performing an ensemble operation by aggregating the predictions generated by the one or more top-performing models to produce a final prediction.

18. A computer-implemented method comprising:
obtaining a configuration file;
automatically preparing data based on the configuration file by:
retrieving data from one or more data sources identified in the configuration file; and
validating the retrieved data by detecting duplicates, null values, and inconsistencies and performing data imputation or removal for detected null values based on predefined rules specified in the configuration file; and
automatically generating predictions by:
obtaining one or more machine learning models; and
applying the one or more models to the prepared data to generate initial predictions; and
providing output based on the generated predictions.

19. The method of claim 18, wherein providing the output comprises generating a visualization of the predictions through a graphical user interface (GUI).

20. The method of claim 19, wherein the GUI comprises a filter configured to receive a user-specified parameter for filtering prediction results.
